(19) United States
(12) Patent Application Publication
(10) Pub. No.: US 2011/0103364 A1
(43) Pub. Date: May 5, 2011

(54) CODE DIVISION MULTIPLE ADDRESS CODING METHOD

(75) Inventor: Daoben Li, Shenzhen (CN)

(73) Assignee: Research Institute of Tsinghua University in Shenzhen, Shenzhen (CN)

(21) Appl. No.: 12/558,525

(22) Filed: Sep. 13, 2009

(51) Int. Cl. H04L 12/44; H04W 8/00

(52) U.S. Cl. 370/342

(57) ABSTRACT

The present invention provides a code division multiple address coding method which uses related random variables or some constants such as time, space and frequency as the coding element. The encoding procedure includes following steps: selecting the basic orthogonal perfect complementary dual code; selecting the basic time, space and frequency coding expansion matrix; constituting a perfect orthogonal complementary code pairs mate; expanding the length and the number of the code group in accordance with the law of spanning tree; completing the coding by transforming the spanning tree. The Code Division Multiple Access (CDMA) system or other wireless communication systems using the present address coding can achieve not only high spectral efficiency, high capacity, but also a strong anti-fading ability, namely, the systems can obtain high hidden diversity numbers, high transmission reliability and low receiver threshold SNR (signal to noise ratio), which meet the project implementation requirements of high reliability and high transmission speed with only a very small portion of transmitting power.

### TECHNICAL FIELD

This invention relates the field of Code Division Multiple Address (CDMA) Mobile Digital Wireless Communications, especially concerning a kind of multi-address block coding method, which has high spectrum efficiency, high anti-fading property and high transmission reliability. Specifically, it is mainly about the multi-address block coding method which depends on time, space and multi-address frequency.

### BACKGROUND

It is the most fundamental task to increase the system capacity and spectrum efficiency, as well as the reliable transmission ability for any Wireless Communication System (WCS), especially in the Mobile Digital Wireless Communication Systems.

The spectrum efficiency means the maximal total messaging rates that per bandwidth can support in a given system bandwidth within the framework of a cell or sector, whose measurement unit is bps/Hz/cell (sector). The transmission reliability is the capability of anti-decline (fading) of a system.

As is known to all, Wireless Channel, especially the Mobile Wireless Channel, is a random time-varying channel. There exists random dispersion in the time domain, frequency domain and space domain, which can result in serious decline of the received signal in the corresponding domains. What is more, the decline will deteriorate the transmission reliability and spectrum efficiency of WCS.

The only way to withstand the fading is diversity. The basic indicator to measure the ability of anti-decline is the diversity multiplicity. Diversity includes apparent diversity and hidden diversity. The apparent diversity, as the name suggests, does not need to elaborate. The hidden technology is a technology to design the spread spectrum signal. For instance, in the Spread Spectrum Wireless Communication System and CDMA system, the technology used for the system is the spread spectrum signal design, which has the capability to confront the frequency selective fading due to the time proliferation of the channel. The substance of the diversity lies in that the sending end transmits the information through loading the transmission information to the sub-channel of irrelevant or independent decline, while the receiver terminal puts the output of the sub-channel together and demodulates the information they load integrated. The number of the available irrelevant or independent decline of the sub-channel is called the order of uncorrelated diversities. The higher the order is, the better the transmission reliability of the system. Generally speaking, after the basic parameters of the channel and communication system are certain, the maximal un-correlation or the order of uncorrelated diversities, namely the largest transmission reliability the system can achieve can be certain.

For a WCS, there are three basic parameters: the system bandwidth B (Hz); the symbol duration T_{M} (s) or the symbol rate 1/T_{M} (sps) and available geospatial range R (M²). For a channel, there are also three basic parameters: the amount of the effective time spread Δ (s) or the effective correlated bandwidth

$$\mathring{Ω} = \frac{1}{Δ} ( Hz ) ;$$

the effective frequency spreading capacity [symbol] (Hz) or the effective correlated time

$$\mathring{t} = \frac{1}{\mathring{F}} ( s ) ;$$

and the effective geographical correlated space of the channel (M²). When the parameters mentioned above are certain, the maximal irrelevant hidden diversity order of the system can attain the following results:

The hidden frequency diversity multiplicity

$${K}_{f} = ⌊ \frac{B}{\mathring{Ω}} + 1 ⌋ = ⌊ B Δ + 1 ⌋ ;$$

The hidden time diversity multiplicity

$${K}_{t} = ⌊ \frac{{T}_{M}}{\mathring{t}} + 1 ⌋ = ⌊ \mathring{F} {T}_{M} + 1 ⌋ ;$$

The hidden space diversity multiplicity

$${K}_{s} = ⌊ \frac{R}{\mathring{R}} + 1 ⌋ .$$

Here, the symbol └┘ indicates the minimum positive integer of , as the order of uncorrelated diversities must be an integer.

The total order K of uncorrelated diversities achieved by the system is: K=K_{f}·Kₜ·Kₛ

Generally speaking, it is contradictory to improve the hidden frequency diversity multiplicity K_{f} and the hidden time diversity multiplicity Kₜ as well as the increase of the spectrum efficiency. Because once given the channel,

$$\mathring{Ω} = \frac{1}{Δ} and \mathring{t} = \frac{1}{\mathring{F}}$$

can then be determined. Improving K_{f} means increasing the frequency resources B occupied by the system, and improving Kₜ means increasing the time resources T_{M}, both of which means reducing of the spectrum efficiency. The space diversity multiplicity Kₛ is an exception.

Like the other multiple access technology, in the CDMA system, users of different addresses have their special address code for mutual recognition. The best address code can still discriminate well and there is no mutual interference after the transmission across the channel, that is, they should keep orthogonal all the time. However, it is regrettable that any Wireless Channel, especially the Mobile Wireless Channel is not the time invariant and non-proliferation system. All of them exist the random angular spreading which produces the space selective fading, and the random frequency diffusion which produce the time selective fading, as well as the random time proliferation which produce the frequency selective fading. The fading does not only seriously deteriorate the system performance, but reduce the system capacity and the efficiency of spectrum substantially. In particular, the time proliferation of the channel which is caused by multi-path propagation can make the overlaps that result in interference among adjacent symbols. This will cause the inter-symbol interference (ISI) in the adjacent symbols for users with the same address. But for users with the different addresses, multiple access interference (MM) will emerge, whose root cause is that the orthogonality of any orthogonal codes may be destroyed in general when the relative delay does not mean zero among address signals.

In order to make the ISI equals zero, the autocorrelation function of all address codes should be an impulse function. That is to say, except the origin, the value of the autocorrelation function corresponding to all kinds of relative delay should be zero. In order to make the MAI equals zero, the value of the cross correlation function corresponding to delay among all the address codes also ought to be zero.

The value of the autocorrelation function in the origin is vividly called the main peak of the correlation function, while the value of the autocorrelation or the cross correlation function outside of the origin is called the secondary peak. The secondary peak of the ideal address code is zero everywhere. However, it is regrettable that there isn't multi-address code group that the secondary peak equals to zero in the real world, which has been proved by theory and rounded search. In particular, the Welch border have pointed that the secondary peak of autocorrelation function and the secondary peak of the cross correlation function is a pair of contradiction. When one diminishes, the other one increases, vice versa.

The previous PCT patent application with Patent No PCT/CN00/0028 by Dao Ben Li publishes a multi-address coding method that has a zero correlation window. The method guarantees that the secondary peak of the address code of the complemented autocorrelation function and the cross correlation function equals to zero, when the codes are encoded in a particular window (−Δ, Δ). Then, when Δ is greater than the maximal time spread capacity plus timing error of the channel, the ISI and MM will not occur for any Bidirectional Synchronization Wireless Communication System.

Practice has proved that the LAS-CDMA MCS based on the invention mentioned above has higher system capacity and spectrum efficiency compared to any other communication system of the same kind. However, people always hope to move forward. Totally, there are mainly two points in the hope:

1. In the given width of the window (−Δ, Δ), may the number of the address code be much more? On the other hand, may the window be wider when the number of the address code is equivalent?

2. Are more strong hidden diversity capability and higher transmission reliability all available at the same time to the address code itself?

To the demand 1, if we continue using the signal of the inventor, suppose orthogonal complementary code group which has zero correlation window are {Cₖ,Sₖ}, 1≦k≦K, the length of code Cₖ and Sₖ is N, he width of the window is (−Δ, Δ). Theory has proven the number of the code K should meet the following infinitive:

$$K \leq \frac{2 ( N + Δ )}{Δ + 1}$$

That is, when N and Δ are given, whatever coding elements are used, including the random elements the invention used. It is impossible that there exists greater address code when the number of the max possible code K is certain. The number of the address code provided by the inventor has gained on the theory border. Basically, there is not much space to improve.

However, taking engineering needs into account, people indeed have the above expects. The only way to resolve is to loosen some constraints terms of the encoding. When one or some constraints is loosed, it only impact little on rare unimportant indicators or complexity of the system. For the whole system, such as capacity, spectrum efficiency, there are not apparent improvements. So, we may encode considering the new loosed constraints.

The fatal shortcoming of the traditional CDMA system is “Near-far Effect”, which is caused by the unsatisfactory feature of the address code, because the main peak of a remote weak signal may be submerged by the strong vice-peak close by. It is known to us that only main peak is the useful signal. In order to overcome the fatal impact of the far effect, the traditional CDMA system use the strict swift power control technology, attempting to make the strength of the signal of the users of different address are roughly the same when they reached the receiver. However, practice has proved that the effect is very limited. The best way in theory is to ensure the cross correlation function of different address code doesn't have the vice-peak in the work environment, which is the way the LAS-CDMA system used. The method has indeed been proved the best both in theory and in practice. As a result, the request that cross correlation function has a zero correlation window can not be relaxed. So what about the loosing of the request of the vice-peak of the autocorrelation function? The answer is yes. On the one hand, they can only cause interferes between adjacent symbols, but not to other signals, then the “Near and Far Effect” will not occur. On the other hand, when the vice-peak of the autocorrelation function is not too large, the impact of the auto-interference on the receiver will be little. Theory and practice have proved that the loss to the properties of the receiver will be almost negligible when the order of uncorrelated diversities is higher or even higher (about 0.37) of the vice-peak of the autocorrelation function. So we may lose the restrictions with the vice-peak of the autocorrelation function appropriately in the window. Furthermore, we may provide a group of autocorrelation and cross correlation function whose codes are not ideal to a address user in the window. Then they are viewed “autocorrelation”. Then it will be ok as long as it can make sure that the address code group's cross correlation function have zero correlation windows.

### SUMMARY

The purpose of the invention is to provide a kind of time, space, frequency multi-address block coding method. There are zero correlation windows of the cross correlation function between group and group. Each group code contains number of codes. While the code's autocorrelation and cross correlation function doesn't require to have the characteristics of “zero correlation window”, the invention can supply many more address codes on the condition that the width of the windows are the same based on the method the invention provide. On the contrary, the invention can provide the wider window when the number of the address code is the same, thereby it creates the condition that can increase the capacity and spectrum efficiency to a large extent.

The other important purpose of the invention is to make the address code encoded have high transmission reliability, namely the multiplicity of the hidden diversity is high. At the same time, the spectrum efficiency will rise or remain unchanged.

As it is required that each address user use a group of code in the invention, although the autocorrelation and cross-correlation function are not ideal among the codes in a group, codes are used by the same user, and the channel fading is exactly the same, as well as the code number is a fixed limited number, all of which bring the convenience to the joint multi-code detection, and resolve the complexity of the joint detection the traditional CDMA system have.

### THE TECHNICAL DETAILS OF THE PRESENT INVENTION

The multiple address coding method uses related random variables or some constants such as time, space and frequency as the coding element. The features of the method are reflected in the following steps:

a) Choosing the basic perfect orthogonal complementary code pairs mate;

b) Choosing the basic time, space, frequency coding expansion matrix;

c) Constituting the basic orthogonal perfect complement dual code group;

d) Expanding the length and the number of the code group in accordance with the law of spanning tree;

e) Transform spanning tree.

The choosing of the basic orthogonal perfect complement dual code mentioned above also includes the following concrete steps:

a) In accordance with the requirements of the width of the zero correlation window required and the code number within the code group, the length N of the basic orthogonal perfect complementary code pairs mate can be settled.

b) According to the relational expression N=N₀×2^{l}; l=0, 1, 2, . . . , the length of a minimum basic perfect complementary code N₀ can be decided;

c) In accordance with the minimum code length decided by the above steps and the requirements of the project implementation, the code [symbol] with the minimum code length can be selected arbitrarily, where [symbol] =[C₁₁; C₁₂, . . . C_{1N}_{₀}];

d) According to the fully complementary requirements of the autocorrelation function, the code [symbol] which is fully complementary with the code [symbol] can be solved by working out the simultaneous equations system mathematically, where [symbol] =[S₁₁, S₁₂, . . . S_{1N}_{₀}];

e) Based on the minimum basic complementary code ( [symbol] ) solved by the above-mentioned steps, another minimum basic complementary code ( [symbol] ) which is totally orthogonally complementary to ( [symbol] ) can be solved;

f) The perfect orthogonal complementary code pairs mate with the required length of N=N₀×2^{l} (l=0, 1, 2, . . . ) can be formed from the perfect orthogonal complementary code pairs mate with the length of N₀.

The choosing of the basic orthogonal perfect complement dual code mentioned above also includes the following concrete steps:

a) In accordance with the requirements of the width of the zero correlation window required and the code number within the code group, the length N of the basic orthogonal perfect complementary code pairs mate can be settled;

b) According to the relation N=N₀₁×N₀₂×2^{l+1}; l=0, 1, 2, . . . , the length of two minimum basic perfect complementary codes N₀₁, N₀₂ can be decided;

c) In accordance with the minimum code length decided by the above steps and the requirements of the project implementation, the code [symbol] with the minimum code length can be selected arbitrarily, where [symbol] =[C₁₁, C₁₂, . . . C_{1N}_{₀}];

d) According to the fully complementary requirements of the autocorrelation function, the code [symbol] which is fully complementary with the code [symbol] can be solved by working out the simultaneous equations system mathematically, where [symbol] =[S₁₁, S₁₂, . . . S_{1N}_{₀}];

e) By repeating the above steps, the two pairs of ( [symbol] ) and ( [symbol] ) can be solved;

f) Based on the minimum basic complementary code ( [symbol] ) solved by the above-mentioned steps, another minimum basic complementary code ( [symbol] ) which is totally orthogonally complementary to ( [symbol] ) can be solved;

g) The perfect orthogonal complementary code pairs mate with the required length of N=N₀×2^{l} (l=0, 1, 2, . . . ) can be formed from the perfect orthogonal complementary code pairs mate with the length of N₀.

The length of the new perfect orthogonal complementary code pairs mate can be doubled by coupling the short code in the following steps:

C₁= [symbol] ; S₁=

[symbol]

C₂= [symbol] ; S₁=

[symbol]

The length of the new perfect orthogonal complementary code pairs mate can be doubled as well in the following steps:

The parity bits of the code C₁(S₁) is composed of [symbol] and [symbol] respectively; the parity bits of the code C₂(S₂) is composed of [symbol] and [symbol] respectively.

The length of the new perfect orthogonal complementary code pairs mate can be doubled by coupling the short code in the following steps:

C₁= [symbol] ; S₁=

[symbol]

C₂= [symbol] ; S₂=

[symbol]

The length of the new perfect orthogonal complementary code pairs mate can be doubled as well in the following steps:

The parity bits of the code C₁ is composed of [symbol] and [symbol] respectively; the parity bits of the code S₁ is composed of [symbol] and [symbol] respectively; the parity bits of the code C₂ is composed of [symbol] and [symbol] respectively; the parity bits of the code S₂ is composed of [symbol] and [symbol] respectively.

The required length N of the new perfect orthogonal complementary code pairs mate can be obtained by continuous use of the steps mentioned above.

The selected basic time, space, frequency coding expansion matrix also includes the following steps:

a) In accordance with the size of the required zero relevant window Δ, the number of columns L of the expansion matrix can be resolved by the relation Δ≧NL−1, where N denotes the length of the basic perfect orthogonal complementary dual code, L represents the number of columns of the expansion matrix, the unit of Δ is calculated by the number of chips;

b) According to engineering requirements for the available time, frequency, size of the space and system complexity, the number of the basic weak-related random variables (code elements) can be selected;

c) According to the complexity of the system and the requirements to improve the efficiency of spectrum, the number M of each group address code can be decided, where M represents rows of the expansion matrix;

d) According to the number of the weak-related random variables for available time, frequency and space, as well as the required rows M and columns L of the expansion matrix, the basic coding expansion matrix can be structured.

The basic coding expansion matrix can be structured with the following basic requirements:

a) Each row vectors should be arranged as many as possible of the weak-correlated random elements, or only constant elements;

b) The expand matrix should be a row full-rank matrix, that is, each row vector should be linear independent;

c) The vice peak of the cycle and the acylic autocorrelation function of each row vectors should be as small as possible;

d) The vice peak of the cycle and the acylic autocorrelation function of each column vectors should be as small as possible;

e) The basic coding expansion matrix can be a random matrix, a constant matrix, or even can be a constant.

The number of weak-correlated random elements in the row vectors is equal to the hidden diversity multiplicity of the WCS.

Whether the autocorrelation function within the window of the group code is good or not is decided by the autocorrelation function of each row vector.

Whether the cross correlation function within the window of the group code is good or not is decided by the cross correlation function of each row vector.

The basic perfect orthogonal complementary code pairs mate group are generated by basic perfect orthogonal complementary code pairs mate and the basic time, space, frequency coding expansion matrix.

Each expanded address code group possess the corresponding category and number of hidden diversity multiplicity with the random variables, at the same time, there is a zero correlation window in the vicinity of the origin among cross correlation functions of different address codes in different code groups. The width of the window is determined by the basic length of the perfect orthogonal complementary code pairs mate group.

The expansion of basic perfect orthogonal complementary code pairs mate group is carried out in accordance with the relation of the spanning tree, where the nature of address codes in each code group expanded by the spanning tree is totally determined by the basic perfect complementary code group in the initial roots of the spanning tree.

The mentioned transformed spanning tree can be referred to the exchange between the S code and C code of the spanning tree.

The mentioned transformed spanning tree can be formed by negating one of the S code and C code in the spanning tree, or both taking the reverse form.

The mentioned transformed spanning tree can be generated by the use of inverted sequences, which take the inverse order of the S code and C code at the same time.

The mentioned transformed spanning tree can be formed by interlacing the polarity of the code bits.

The mentioned transformed spanning tree can be formed by uniform rotation transformation of the code bits in the complex plane.

The mentioned transformed spanning tree can be formed by re-arranging the column synchronization of the code C and code S in the spanning tree, where the unit of the column is based on the code of a basic perfect orthogonal complementary code pairs mate group.

The unit of the mentioned address code is the group, and there are a fixed number of codes in each group. The cross-correlation function of the address codes in each code group possesses the zero correlation window.

The hidden diversity multiplicity of the mentioned address code is very high, whose effective diversity multiplicity is equal to the product of the number of weak-correlated time, space, frequency random variables in the coding elements and the time diffusing amount of the chip-based channel in the window.

The unit of the mentioned address code is group, and each group includes a certain number of codes. The cross-correlation function of the codes among different groups possesses the zero-correlated-window feature.

The autocorrelation function of codes among different address code groups and the cross-correlation function of the inter-symbol does not require to be ideal, and the zero correlation window do not necessarily require to exist.

The size of the zero correlation windows can be adjusted among the address code groups.

The adjustment method can be described as the adjustment of the length of the basic orthogonal complementary code pairs mate.

The adjustment method can be described as the adjustment of the number of columns of the basic time, space, frequency expansion matrix.

The adjustment method can be described as the adjustment of the number of zero element of the coding expansion matrix in the spanning tree.

The number of codes within various address code groups can be adjusted through adjusting the number of rows of the basic time, space, frequency coding expansion matrix.

The autocorrelation function of codes within various address code groups is mainly determined by the cross correlation feature of each row of the selected basic time, space, frequency coding expansion matrix, and the cross correlation function of each code within a group is mainly determined by the cross correlation feature of the corresponding rows of the selected time, space, frequency coding expansion matrix within the zero correlation window.

The autocorrelation and the cross correlation feature of each address code including the address code within a group are determined by the basic orthogonal complementary code pairs mate and the structure of the corresponding spanning tree outside the zero correlation window.

The time, space, frequency coding expansion matrix described above can be arbitrary matrix.

The time, space, frequency coding expansion matrix described above can be the time, pace matrix; the time, frequency matrix; the time, space, frequency matrix; and even can be the constant matrix or constant.

The present invention gives a new grouping multiple address coding technology which uses relevant random variables as codes elements, such as time, frequency, space and so on. The basic characteristics of this coding technology are as follows:

1) Address code takes group as a unit, there are fixed-number codes in each group and the cross-correlation function between address codes has the characteristic of zero correlation windows. While the width of the windows is the same or broader and the length of address codes is longer, comparing with the multi-address code invented by Dao Ben Li in PCT/CN00/0028 invention, the number of the groups of the address codes provided in this invention are the same, but there are multiple codes in the group, so the total number of the codes provided by this invention has been greatly improved than the former and the contrary is also true. Therefore, the wireless communication system which uses this invention as the address codes will has higher system capacity and higher spectrum efficiency.

2) Because the elements of address codes are weak correlation random variables of time, space or frequency etc, the constructed address codes also have a higher order of uncorrelated hidden diversities, which will enable the reliability of transmission of the system greatly enhanced. Its effective order of uncorrelated diversities equals to the product of the number of the weak correlation random variables of time, space or frequency and etc in the coding elements and the chip-based channel time dispersion capacity in the “window”. For example, the elements of the address codes use four decline random variables of dual-band and double space, the time dispersion capacity of the channel has the length of three chips, and the actual system which uses the address codes will be 4×3=12 times the diversity effect, so transmission reliability has been very close to the non-decline parametric stabilization Gaussian channel.

3) The address codes are in “group” terms, the cross-correlation function of the codes among different groups has the characteristic of “zero correlation window”, if the width of the “window” is wider than the time diffusing capacity plus system timing error of the practical channel, at the same time, each user use one group of codes in the inner system, then the corresponding wireless communication system will not have the “near-far effect”, and the capacity and spectral efficiency of the system will have a greatly increase.

4) In the address codes, the auto-correlation function of the code and the cross-correlation function between codes are not necessarily ideal, and not necessarily have the “zero-correlation window” This requires using multi-code (multi-user) joint detection techniques in practice, in order to reduce the group interference, because codes of the group are commonly used by one user, the channel fading characteristic is in full agreement, meanwhile the number of codes of group is generally not many, which brings convenience to applying multi-code joint detection, multi-code interference cancellation, multi-code equilibrium techniques and so on.

5) The width of “zero correlation window” of the cross-correlation function between different groups of address codes can be adjusted by the following means:

a) Adjust the length of basic complementary orthogonal code pair mate;

b) Adjust the number of column of the basic time, space, frequency codes expanding matrix;

c) Adjust the number of element 0 in the spanning tree expanding matrix.

6) The number of codes in different address code groups can be adjusted by adjusting the row number of the basic time, space, frequency expanding matrix.

7) In the window, the autocorrelation function of each code in each group of address codes mainly depends on the autocorrelation characteristic of each corresponding row of the selected basic time, space, frequency codes expanding matrix. Meanwhile, the cross-correlation function between the codes in each group mainly depends on the cross-correlation characteristic between the corresponding rows of the selected basic time, space, frequency codes expanding matrix. So it is important to choose an expanding matrix with good characteristic of each column's auto-correlation function and each row's cross-correlation function.

8) Out of the window, the autocorrelation and cross-correlation characteristics of each address code (including in the group) depend on the structures of the basic complementary orthogonal code pair mate and the corresponding spanning tree.

9) The time, space, frequency codes expanding matrix can be arbitrary, such as time and space; time and frequency; time, space and frequency, even the constant matrix. The only difference lies in the types of the diversity and whether it has the diversity or not.

### BRIEF DESCRIPTION OF THE DRAWINGS

For the full understanding of the nature of the present invention, reference should be made to the following detailed descriptions with the accompanying drawings in which:

FIG. 1 is the basic code spanning tree;

FIG. 2 is the instance of the specific case of the implementation of the code spanning tree;

FIG. 3a is the original pareto diagram of the column transformation of the spanning tree;

FIG. 3b is the new pareto diagram after transforming the second and the third column of the spanning tree.

Like reference numerals refer to like parts throughout the several views of the drawings.

### DESCRIPTION OF THE PREFERRED EMBODIMENT

Then I will explain the specific ways of this invention combining with the attached figures.

The basic coding steps of this invention are as follows:

Step 1: The selection of Basic perfect complementary orthogonal code pairs mate.

The step can be broken down as follows:

1) According to the requirements of the width of “zero correlation window” required and the number of codes in the code groups, we can decide the length of the basic perfect complementary orthogonal dual code N.

2) According the following relation N=N₀×2^{l}; l=0, 1, 2, . . . First determine the length of the shortest perfect complementary code N₀. For example we require N=12, then N₀=3, l=2

3) Or according to the relation: N=N₀₁×N₀₂×2^{l+1}; l=0, 1, 2, . . . First determine the length of two shortest perfect complementary code N₀₁, N₀₂. For example, we require N=30, then N₀₁=3, N₀₂=5 (l=0).

4) According to the shortest code length determined by 2) or 3), and the requirement of project realization, choose a code [symbol] with the shortest code length arbitrary, where [symbol] =[C₁₁, C₁₂, . . . C_{1N}_{₀}].

5) According to the requirement that the autocorrelation function completely complementary to each other, using mathematical solution of simultaneous equations approach, to solve the code [symbol] which completely complement with the autocorrelation function of [symbol] , where [symbol] =[S₁₁, S₁₂, . . . S_{1N}_{₀}]

We can obtain the element of [symbol] from the following groups of simultaneous equations

C₁₁·C_{1N}_{₀}=−S₁₁·S_{1N}_{₀}

C₁₁·C_{1N}_{₀}₋₁+C₁₂·C_{1N}_{₀}=−(S₁₁·S_{1N}_{₀}₋₁+S₁₂·S_{1N}_{₀})

C₁₁·C_{1N}_{₀}₋₂+C₁₂·C_{1N}_{₀}₋₁+C₁₃·C_{1N}_{₀}₋₁+C₁₃·C_{1N}_{₀}=−(S₁₁·S_{1N}_{₀}₋₂+S₁₂·S_{1N}_{₀}₋₁+S₁₃·S_{1N}_{₀})

C₁₁·C₁₂+C₁₂·C₁₃+ . . . +C_{1N}_{₀}₋₁·C_{1N}_{₀}=−(S₁₁·S₁₂+S₁₂·S₁₃+S_{1N}_{₀}₋₁·S_{1N}_{₀})

The code [symbol] get from the above-mentioned solution of simultaneous equations o, there are many solutions in general, you can choose one of them as code [symbol] .

### Example 1

if [symbol] =+++, here + represents +1; − represents −1, there are many possible solutions of [symbol] , such as

+0+; −0−; +j+; +−j+; −j−; −−j−, and so on.

### Example 2

if [symbol] =+++, the possible solutions of [symbol] are:

\sqrt{2}−1, 1,

$$- \frac{1}{\sqrt{2} - 1} ;$$

\sqrt{2}+1, 1,

$$- \frac{1}{\sqrt{2} + 1} ;$$

a,

$$\frac{- 2 a}{{a}^{2} - 1} , - \frac{1}{a} ,$$

and so on, here a is any number except +1 or −1.

### Example 3

if [symbol] =1, 2, −2, 2, 1; one solution of [symbol] is

1, 4, 0, 0, −1, and so on.

If the primary choice value of [symbol] isn't proper, it may be no solution for [symbol] ; despite there is solution sometimes, it is not easy to work on the project application, at this time, we should re-adjusted the value of [symbol] , until we are satisfied with the value of [symbol] and [symbol] .

6) If according to 3), since there are two shortest length N₀₁, N₀₂, repeat 4), 5), solving two couples of ( [symbol] ) and ( [symbol] ).

### Where =C₁₁′, C₁₂′, . . . , C_{1N01}′; =S₁₁′, S₁₂′, . . . , S_{1N01}′

[symbol] =C₂₁′, C₂₂′, . . . , C_{2N02}′; [symbol] =S₂₁′, S₂₂′, . . . , S_{2N02}′

And solve the complete complement code pair ( [symbol] ) with the length of 2N₀₁×N₀₂, using the rules as follows, where

[symbol]

=[C₁₁′·[C₂₁′,C₂₂′, . . . ,C_{2N02}′],C₁₂′·[C₂₁′,C₂₂′, . . . ,C_{2N02}′], . . . ,C_{1N0}_{₁}′[C₂₁′,C₂₂′, . . . ,C_{2N02}′],S₁₁′[S₂₁′,S₂₂′, . . . ,S_{2N02}′],S₁₂′[S₂₁′,S₂₂′, . . . ,S_{2N02}′], . . . ,S_{1N0}_{₁}′[S₂₁′,S₂₂′, . . . ,S_{2N02}′]],

[symbol]

=[C₁₁′·[S_{2N02}′,S_{2N02-1}′, . . . ,S₂₂′,S₂₁′],C₁₂′·[S_{2N02}′,S_{2N02-1}′, . . . ,S₂₂′,S₂₁′], . . . ,C_{1N01}′[S_{2N02}′,S_{2N02-1}′, . . . ,S₂₂′,S₂₁′],−S₁₁′[C_{2N02}′,C_{2N02-1}′, . . . ,C₂₂′,C₂₁′],−S₁₂′[C_{2N02}′,C_{2N02-1}′, . . . ,C₂₂′,C₂₁′], . . . ,−S_{1N01}′[C_{2N02}′,C_{2N02-1}′, . . . ,C₂₂′,C₂₁′]]

Both of their length is 2N₀₁×N₀₂.

Mathematically expressed as: [symbol] = [symbol] ,

[symbol]

$$\mathring{{S}_{1}} = \mathring{{C}_{1}^{′}} ⊗ \underline{\mathring{{S}_{2}^{′}}} , {{S}_{1}^{′}}^{\underline{∘}} ⊗ \underline{\mathring{{C}_{2}^{′}}}$$

In the formula [symbol] means Kroneckzer product; means inverted sequence; means non-sequence, that is to take the opposite value of the elements.

7) According to the shortest basic complementary code pair ( [symbol] ) solved by 5) 6), we can work out another shortest basic complementary code pair which is complete orthogonal complementary with it.

{( [symbol] ); ( [symbol] )} is called perfect complementary orthogonal code pairs mate. In other words, in sense of complementary, the auto-correlation function for each pair of codes, as well as the cross-correlation function between the two pairs are ideal.

Theory and rounded search has proved that, for any complementary pair, there is only one complementary code pair ( [symbol] ) which is mated with it, and they meet the following relationship:

$$\mathring{{C}_{2}} = k {{S}_{1}^{*}}_{\_}^{∘} ; \mathring{{S}_{2}} = k \overline{{{C}_{1}^{*}}_{\_}^{∘}} ;$$

Here: underline means inverted sequence, that is, reverse the order (from head to tail); online means non-sequence, that is to take the opposite value of all the elements; * means complex conjugate; k means any complex constant.

### Example

if [symbol] =++−; [symbol] =+j+; Order k=1, so [symbol] =+−j+; [symbol] =+−−

TABLE 1
The autocorrelation function of ( [symbol] )
R₁(τ)ΔR_{c}_{₁} (τ) + Rₛ_{₁} (τ)

| | The value of the | | | | |
|---|---|---|---|---|---|
| | symmetric space τ τ | | | | |
| | −2 | −1 | 0 | 1 | 2 |
| R₁(τ) | 0 | 0 | 6 | 0 | 0 |

[symbol]

= + + −; [symbol]
= + j + [symbol]
= + −j +; [symbol]
= + − −

TABLE 2
The autocorrelation function of ( [symbol] )
R₂(τ)ΔR_{c}_{₂} (τ) + Rₛ_{₂} (τ)

The value of the
symmetric space τ τ

| | −2 | −1 | 0 | 1 | 2 |
|---|---|---|---|---|---|
| R₂(τ) | 0 | 0 | 6 | 0 | 0 |

[symbol]

= + −j +; [symbol]
= + − −

TABLE 3
The cross-correlation function between ( [symbol] ) and ( [symbol] )
R₁₂(τ)ΔR_{c}_{₁}_{c}_{₂} (τ) + Rₛ_{₁}ₛ_{₂} (τ)

| | The value of the | | | | |
|---|---|---|---|---|---|
| | symmetric τ | | | | |
| | −2 | −1 | 0 | 1 | 2 |
| R₁₂(τ) | 0 | 0 | 0 | 0 | 0 |

[symbol]

= + + −, [symbol]
= + j +; [symbol]
= + −j +, [symbol]
= + − −

Tables 1 to 3 list their value of autocorrelation function and cross-correlation function in sense of complementary, we can see that they are ideal.

8) Generating perfect complete orthogonal complementary code pairs mate with the required length of N=N₀×2^{l} (l=0, 1, 2, . . . ) from that with the length of N₀.

If ( [symbol] ) and ( [symbol] ) is a perfect complete orthogonal complementary code pairs mate, We can use the following four simple ways to redouble its length, and the new code pair after we double the length is also a perfect complete orthogonal complementary code pairs mate.

The first method: connect the short codes with the following way:

### C₁=; S₁=

### C₂=; S₁=

The second method:

The parity bit of code C₁(S₁) is made up of [symbol] and [symbol] .

The parity bit of code C₂(S₂) is made up of [symbol] and [symbol] .

### Example

if [symbol] =[C₁₁C₁₂ . . . C_{1N}_{₀}], [symbol] =[S₁₁S₁₂ . . . S_{1N}_{₀}]
[symbol] =[C₂₁C₂₂ . . . C_{2N}_{₀}], [symbol] =[S₂₁S₂₂ . . . S_{2N}_{₀}]

Then C₁=└C₁₁C₂₁C₁₂C₂₂ . . . C_{1N}_{₀}C_{2N}_{₀}┘, S₁=└S₁₁S₂₁S₁₂S₂₂ . . . S_{1N}_{₀}S_{2N}_{₀}┘
C₂=[C₁₁ C̅₂₁C₁₂ C̅₂₂ . . . C_{1N}_{₀} C̅_{2N}_{₀}], S₂=[S₁₁ S̅₂₁S₁₂ S̅₂₂ . . . S_{1N}_{₀} S̅_{2N}_{₀}]

The third method: connect the short codes with the following way:

### C₁=; S₁=

### C₂=; S₂=

The fourth method:

The parity bit of code C₁ is made up of [symbol] and [symbol] ;

The parity bit of code S₁ is made up of [symbol] and [symbol] ;

The parity bit of code C₂ is made up of [symbol] and [symbol] ;

The parity bit of code S₂ is made up of [symbol] and [symbol] .

There are many other equivalent ways will not be given here.

By using these methods repeatedly, we can form perfect complementary orthogonal code pairs mate with the required length N finally.

Step 2: The selection of basic time, space, frequency codes expanding matrix

The basic time, space, frequency codes expanding matrix is an important part to the expanding from the basic “zero correlation window” coding between codes to the “zero correlation window” coding between code groups. Since the introduction of this expanding matrix is in condition of the same “window” width, the code number provided by this invention can be increased substantially, on the contrary, with the same code number, this invention can provides broader “zero correlation window”.

If the order of the expanding matrix is M×L, here M represents the rows of the extended matrix, L represents the columns of the expending matrix, generally speaking, the larger M×L, the higher the spectrum efficiency of the address codes formed, at the same time, the higher the order of uncorrelated diversities of the corresponding to the communications system, and the higher the reliability of said transmission system, the smaller transmitting power required for the system relatively, but the complexity of the system have also increased.

To expand Matrix M equal to the number of rows within the code group code number. M is, the higher the efficiency of the system of the spectrum, but the resulting complexity of the system also higher.

The column of the expanding matrix L is related to the width of “the zero correlation window” for the cross-correlation function between the address codes formed. The larger L is, the wider of the window. In general L is greater than or equal to the order of uncorrelated diversities of the system, that is, the order of the weak correlation of time, space, frequency of random variables provided in actual, the number of these random variables is the elements of the expansion matrix. In the traditional design of the system, people often do not request the relevant diversity, which will lead to a request that coding elements should be irrelevant or declining independent. However, in a certain range of possible space, such as the constrains—geo-spatial dimensions, processing time, the system bandwidth can be used, the number of the irrelevant or declining independent random elements can be used will be limited. Theory and practice have both shown that relaxation can be properly used by the random element of relevance. Professor Dao Ben Li in his book raised in the e⁻¹ guidelines, that is, zero correlation with the correlation high to e⁻¹ (about 0.37) almost have no difference in performance. According to the experiments results, relevance can even be relaxed to about 0.5, thus it can reach higher order of uncorrelated diversities in a given possible “space” that can be handled with, but the relevance of further easing would not be desirable, although this will bring higher order of uncorrelated diversities, but a truly effective order re-raising is very limited. Hence the relaxation of the relevance should be proper.

The step 2 can be divided as follows:

(1) According to size of “the zero correlation window” Δ, we can determine the column of the expanding matrix L by the relationship Δ≧NL−1, here N is the length of the perfect complete orthogonal complementary code pairs mate; L is the column of the expansion matrix; Δ is measured by the number of the code chips.

2) According to the “space” size of the available time, frequency, space and the project requests such as the size and the complexity of the system, we choose the number of basic “weak” related random variable (coding element).

3) According to the system complexity and the need of rising the efficiency of the frequency spectrum, decide the number of the integer code M of each “group” of address code, M is the row of the expansion matrix.

4) According to the number of the available time, frequency, space weak related random variable (coding element), the row of the expanding matrix M and the column L required, construct the basic coding expansion matrix. This matrix should only be satisfied with the following four basic conditions:

a. We should arrange as more “weak” related random elements as possible in each row vector of the matrix;

b. This expansion matrix should be the good non-singular matrix, that is each row vector should be linear independent;

c. The non cycle and cycle autocorrelation function of each row vector should have the negative peak as “small” as possible, for example the absolute value is no bigger than e⁻¹ or even above 0.5;

d. The non cycle and cycle autocorrelation function between each two row vectors should have the negative peak as “small” as possible, for example the absolute value is no bigger than e⁻¹ or even above 0.5;

Where,

a) The “weak” related random elements of each row vector is the order of uncorrelated diversities of the corresponding wireless communication system;

b) The quality of the autocorrelation function of each row vector will decide the quality of the autocorrelation function of the in-group corresponding code in the “window”;

c) The quality of the autocorrelation function between the row vectors will decide the quality of the cross-correlation function between the in-group corresponding codes in “the window”;

There are several kinds of practical basic time, space, frequency coding expansion matrix:

a) The row and the column of the coding expansion matrix M=L=2, the random variable number is 2.

Expanding matrix for the basic coding is

$$[ \begin{matrix}{a}_{1} & {a}_{2} \\ {a}_{2} & {\overline{a}}_{1}\end{matrix} ] ,$$

This is an orthogonal matrix, a₁, a₂ are two space or polarization or frequency diversity random variables, even two constants. Their relevance is no requirement. When their relevance is 1 (that is a constant matrix), hidden diversity gain disappears, but also useful to improve the system capacity and frequency efficiency.

b) The number of columns of expanding matrix for coding is L=2, rows M=4, and the number of random variables is 4.

The expanding matrix has two basic forms:

Expanding matrix 1 for the basic coding is

$$[ \begin{matrix}\begin{matrix}{a}_{1} & & {a}_{2} \\ & {f}_{1} & \\ {a}_{2} & & {\overline{a}}_{1}\end{matrix} \\ \begin{matrix}{a}_{1} & & {a}_{2} \\ & {f}_{2} & \\ {a}_{2} & & {\overline{a}}_{1}\end{matrix}\end{matrix} ]$$

Up and down the matrix there are two sub-blocks, and a₁, a₂ are two space or polarization diversity random variables up the matrix but carrier frequency is f₁. Down the matrix a₁, a₂ are also two space or polarization diversity random variables but carrier frequency is f₂. The relevance distance of a₁, a₂ these two antenna doesn't make any demands, and even with a₁, a₂ the two constants (including a₁=a₂) can be, but this time there is no space or polarization diversity gain. There are some differences between f₁, and f₂, but there is no requirement for not related decline. This expanding matrix for coding is also applied to multi-carrier, that is

$$[ \begin{matrix}\begin{matrix}{a}_{1} & & {a}_{2} \\ & {f}_{1} & \\ {a}_{2} & & {\overline{a}}_{1}\end{matrix} \\ \begin{matrix}{a}_{1} & & {a}_{2} \\ & {f}_{2} & \\ {a}_{2} & & {\overline{a}}_{1}\end{matrix} \\ M \\ \begin{matrix}{a}_{1} & & {a}_{2} \\ & {f}_{n} & \\ {a}_{2} & & {\overline{a}}_{1}\end{matrix}\end{matrix} ]$$

Where f₁, f₂, . . . fₙ is the carrier of n related fading.

The address code group formed by the said multi-carrier expanding matrix 1 for coding has two abilities of hidden space or polarization diversity. In order to increase the system capacity and spectrum efficiency, we use multi-carrier.

Expanding matrix 2 for the second basic coding matrix is

$$[ \begin{matrix}( \begin{matrix}{f}_{1} & & {f}_{2} \\ & {a}_{1} & \\ {f}_{2} & & {\overline{f}}_{1}\end{matrix} ) \\ ( \begin{matrix}{f}_{1} & & {f}_{2} \\ & {a}_{2} & \\ {f}_{2} & & {\overline{f}}_{1}\end{matrix} )\end{matrix} ]$$

Up and down the matrix there are two sub-blocks, f₁, f₂ are frequency diversity random variables up the matrix, but they use antenna a₁. f₁, f₂ are also frequency diversity random variables down the matrix, but they use antenna a₂. The distance of f₁, f₂ dose not make any demands, and even equal. But this time there is no frequency diversity gain. There should be suitable distance between a₁ and a₂, but there is no requirement for the decline of independent. This matrix can extend to multi-antenna case, that is

$$[ \begin{matrix}( \begin{matrix}{f}_{1} & & {f}_{2} \\ & {a}_{1} & \\ {f}_{2} & & {\overline{f}}_{1}\end{matrix} ) \\ ( \begin{matrix}{f}_{1} & & {f}_{2} \\ & {a}_{2} & \\ {f}_{2} & & {\overline{f}}_{1}\end{matrix} ) \\ M \\ ( \begin{matrix}{f}_{1} & & {f}_{2} \\ & {a}_{n} & \\ {f}_{2} & & {\overline{f}}_{1}\end{matrix} )\end{matrix} ]$$

Where a₁, a₂, . . . , aₙ are antennas that bring related space selective fading.

The address code group formed by the above-mentioned multi-antenna coding expansion matrix 2 has two abilities of hidden frequency diversity. In order to increase the system capacity and spectrum efficiency, we use multi-antenna. Obviously, matrix 1 and matrix 2 can mix.

c) The number of columns and rows of expanding matrix for coding is M=L=4, and the number of random variables is 4.

Expanding matrix for the basic coding is

$$[ \begin{matrix}{a}_{1} & {a}_{2} & {a}_{3} & {a}_{4} \\ {a}_{2} & {\overline{a}}_{1} & {a}_{4} & {\overline{a}}_{3} \\ {a}_{3} & {\overline{a}}_{4} & {\overline{a}}_{1} & {a}_{2} \\ {a}_{4} & {a}_{3} & {\overline{a}}_{2} & {\overline{a}}_{1}\end{matrix} ]$$

It's also an orthogonal matrix, where a₁, a₂, a₃, a₄ can be any space, frequency and polarization diversity random variables or new ones combined, and can also be any constants.

In fact, there are still many applicable expansion matrix for the basic coding. Even constants matrix can do as long as it meets before-mentioned four basic conditions. It should be noted that constants expanding matrix for the basic coding is only useful to increase the system capacity and spectrum efficiency. It will not play any role to improve the reliability of the system transmission, even from the opposite effect.

“Zero correlation window” multi-address coding method which is claimed by Dao Ben Li in PCT/CN00/0028 is just a special case when expanding matrix is a 1×1 matrix (constant) in this invention.

Step three: The structure of basic perfect complementary orthogonal code pairs mate.

The basic perfect complementary orthogonal code pairs mate is created by basic perfect complementary orthogonal code pair mate and basic time, space, frequency expanding matrix for coding. Here is how to generate it:

Supposing that the basic perfect complementary orthogonal code pair mate is ( [symbol] ), ( [symbol] ); expansion matrix for the basic coding is A, where:

### =[C₁₁C₁₂ . . . C_{1N}], =[S₁₁S₁₂ . . . S_{1N}],

### =[C₂₁C₂₂ . . . C_{2N}], =[S₂₁S₂₂ . . . S_{2N}]

$$A = [ \begin{matrix}{a}_{11} & {a}_{12} & Λ & {a}_{1 L} \\ {a}_{21} & {a}_{22} & Λ & {a}_{2 L} \\ M & & & M \\ {a}_{M 1} & {a}_{M 2} & Λ & {a}_{M L}\end{matrix} ]$$

The basic perfect complementary orthogonal code pairs mate, just as its name implies, has two sets of code. There is M pair code each set and the length of code is NL+L−1, Cross-correlation function between code pair in one set and any code pair in the other is perfect in the sense of each other, that is, there is no vice peak completely. However, each code pair in the set does not guarantee to have ideal characteristics neither autocorrelation nor cross-correlation function. For basic perfect complementary orthogonal code pairs mate formed by basic perfect complementary orthogonal code pair mate and expanding matrix for the basic coding, we mark down (C₁,S₁); (C₂,S₂).

Where, Cᵢ= [symbol] A, 0; Sᵢ= [symbol] A, 0, i=1, 2

Here: [symbol] show Kronecker product

0 show M×(L−1) zero matrix.

That is, C₁=[C₁₁A, C₁₂A, . . . , C_{1N}A, 0], S₁=[S₁₁A, S₁₂A, . . . , S_{1N}A, 0];
C₂=[C₂₁A, C₂₂A, . . . , C_{2N}A, 0], S₁=[S₂₁A, S₂₂A, . . . , S_{2N}A, 0]

They are all M×(NL+L−1) matrix. C is the largest range of protection which is set in the interest of separating front and back generating unit in the tree and possible “interference” in the most adverse circumstances. It can be shortened or canceled according to the actual situation. Zero matrix may be located in the head of the group code instead of rump.

For example 1: if basic complementary orthogonal code pair mate are

[symbol] =++, [symbol] =+−;

[symbol] =−+, [symbol] =−+.

They are all vectors that the length of code N=2. The expanding matrix for basic coding is

$$A = [ \begin{matrix}{a}_{1} & {a}_{2} \\ {a}_{2} & {\overline{a}}_{1}\end{matrix} ] ,$$

and it is a orthogonal matrix whose number of columns and rows is M=L=2. So basic perfect complementary orthogonal code pairs mate generated is:

$$\begin{matrix}{C}_{1} = [ \begin{matrix}{C}_{11} \\ {C}_{12}\end{matrix} ] = [ \begin{matrix}{a}_{1} & {a}_{2} & {a}_{1} & {a}_{2} & 0 \\ {a}_{2} & {\overline{a}}_{1} & {a}_{2} & {\overline{a}}_{1} & 0\end{matrix} ] , {S}_{1} = [ \begin{matrix}{S}_{11} \\ {S}_{12}\end{matrix} ] = [ \begin{matrix}{a}_{1} & {a}_{2} & {\overline{a}}_{1} & {\overline{a}}_{2} & 0 \\ {a}_{2} & {\overline{a}}_{1} & {\overline{a}}_{2} & {a}_{1} & 0\end{matrix} ] ; \\ {C}_{2} = [ \begin{matrix}{C}_{21} \\ {C}_{22}\end{matrix} ] = [ \begin{matrix}{\overline{a}}_{1} & {\overline{a}}_{2} & {a}_{1} & {a}_{2} & 0 \\ {\overline{a}}_{2} & {a}_{1} & {a}_{2} & {\overline{a}}_{1} & 0\end{matrix} ] , {S}_{2} = [ \begin{matrix}{S}_{21} \\ {S}_{22}\end{matrix} ] = [ \begin{matrix}{\overline{a}}_{1} & {\overline{a}}_{2} & {\overline{a}}_{1} & {\overline{a}}_{2} & 0 \\ {\overline{a}}_{2} & {a}_{1} & {\overline{a}}_{2} & {a}_{1} & 0\end{matrix} ] .\end{matrix}$$

A zero is only inserted because of L=2. Easily verified and from the simple complementary sense, autocorrelation and cross-correlation functions of two pairs of code in either (C₁, S₁) or (C₂, S₂) are not ideal (appearing two vice peaks). But the sum of auto-correlation function of two pairs of code in the group is still ideal (e.g. table 4, table 5). This is a broader complement each other. The most important characteristic of this expanding coding, from the simple complementary sense, is that the cross-correlation function among different code for each group of code is completely ideal (e.g. table 6).

TABLE 4
autocorrelation and cross-correlation function of (C₁, S₁)
${C}_{1} = [ \begin{matrix}{C}_{11} \\ {C}_{12}\end{matrix} ] = [ \begin{matrix}{a}_{1} & {a}_{2} & {a}_{1} & {a}_{2} & 0 \\ {a}_{2} & {\overline{a}}_{1} & {a}_{2} & {\overline{a}}_{1} & 0\end{matrix} ] , \\ {S}_{1} = [ \begin{matrix}{S}_{11} \\ {S}_{12}\end{matrix} ] = [ \begin{matrix}{a}_{1} & {a}_{2} & {\overline{a}}_{1} & {\overline{a}}_{2} & 0 \\ {a}_{2} & {\overline{a}}_{1} & {\overline{a}}_{2} & {a}_{1} & 0\end{matrix} ]$

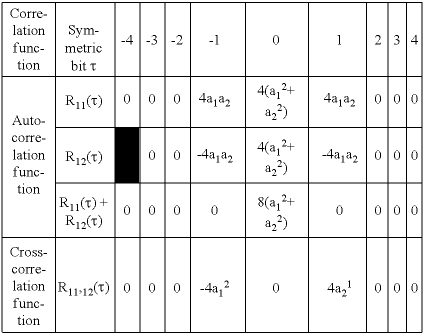

Note: the figure in the shadow does no appear in the structure of spanning tree.

TABLE 5
autocorrelation and cross-correlation function of (C₂, S₂)
${C}_{2} = [ \begin{matrix}{C}_{21} \\ {C}_{22}\end{matrix} ] = [ \begin{matrix}{\overline{a}}_{1} & {\overline{a}}_{2} & {a}_{1} & {a}_{2} & 0 \\ {\overline{a}}_{2} & {a}_{1} & {a}_{2} & {\overline{a}}_{1} & 0\end{matrix} ] , \\ {S}_{2} = [ \begin{matrix}{S}_{21} \\ {S}_{22}\end{matrix} ] = [ \begin{matrix}{\overline{a}}_{1} & {\overline{a}}_{2} & {\overline{a}}_{1} & {\overline{a}}_{2} & 0 \\ {\overline{a}}_{2} & {\overline{a}}_{1} & {\overline{a}}_{2} & {a}_{1} & 0\end{matrix} ]$

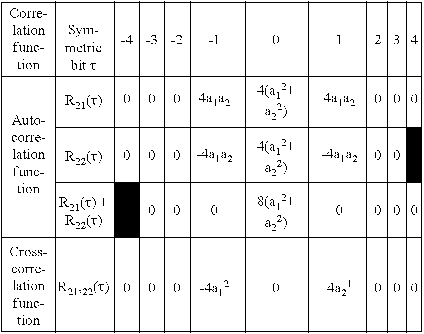

Note: the figure in shadow does not appear in the structure of spanning tree

TABLE 6
the cross-correlation function of code among the different code groups
${C}_{1} = [ \begin{matrix}{C}_{11} \\ {C}_{12}\end{matrix} ] = [ \begin{matrix}{a}_{1} & {a}_{2} & {a}_{1} & {a}_{2} & 0 \\ {a}_{2} & {\overline{a}}_{1} & {a}_{2} & {\overline{a}}_{1} & 0\end{matrix} ] , \\ {C}_{2} = [ \begin{matrix}{C}_{21} \\ {C}_{22}\end{matrix} ] = [ \begin{matrix}{\overline{a}}_{1} & {\overline{a}}_{2} & {a}_{1} & {a}_{2} & 0 \\ {\overline{a}}_{2} & {a}_{1} & {a}_{2} & {\overline{a}}_{1} & 0\end{matrix} ] , \\ {S}_{1} = [ \begin{matrix}{S}_{11} \\ {S}_{12}\end{matrix} ] = [ \begin{matrix}{a}_{1} & {a}_{2} & {\overline{a}}_{1} & {\overline{a}}_{2} & 0 \\ {a}_{2} & {\overline{a}}_{1} & {\overline{a}}_{2} & {a}_{1} & 0\end{matrix} ]$ ${S}_{2} = [ \begin{matrix}{S}_{21} \\ {S}_{22}\end{matrix} ] = [ \begin{matrix}{\overline{a}}_{1} & {\overline{a}}_{2} & {\overline{a}}_{1} & {\overline{a}}_{2} & 0 \\ {\overline{a}}_{2} & {\overline{a}}_{1} & {\overline{a}}_{2} & {a}_{1} & 0\end{matrix} ]$

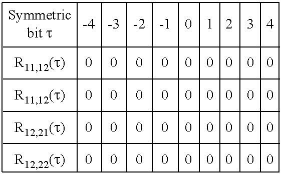

Note: the figure in the shadow does not appear in the structure of spanning tree.

In this case, L=2, N=2, so as the “root” (see below) and the formation of the spread spectrum address code groups unilateral “window” width of the mouth Δ≧3.

Another example: if basic perfect complementary orthogonal code pair mate is ( [symbol] ), ( [symbol] ), therefore: [symbol] =++, [symbol] =+−; [symbol] =−+, [symbol] =−−. They are all vectors whose code length is N=2.

Expanding matrix A for the basic coding is:

$$[ \begin{matrix}{a}_{1} & {a}_{2} & {a}_{3} & {a}_{4} \\ {a}_{2} & {\overline{a}}_{1} & {a}_{4} & {\overline{a}}_{3} \\ {a}_{3} & {\overline{a}}_{4} & {\overline{a}}_{1} & {a}_{2} \\ {a}_{4} & {a}_{3} & {\overline{a}}_{2} & {\overline{a}}_{1}\end{matrix} ]$$

So basic perfect complementary orthogonal code pairs mate is:

$${C}_{1} = [ \begin{matrix}{C}_{11} \\ {C}_{12} \\ {C}_{13} \\ {C}_{14}\end{matrix} ] = [ \begin{matrix}{a}_{1} {a}_{2} {a}_{3} {a}_{4} {a}_{1} {a}_{2} {a}_{3} {a}_{4} 000 \\ {a}_{2} {\overline{a}}_{1} {a}_{4} {\overline{a}}_{3} {a}_{2} {\overline{a}}_{1} {a}_{4} {\overline{a}}_{3} 000 \\ {a}_{3} {\overline{a}}_{4} {\overline{a}}_{1} {a}_{2} {a}_{3} {\overline{a}}_{4} {\overline{a}}_{1} {a}_{2} 000 \\ {a}_{4} {a}_{3} {\overline{a}}_{2} {\overline{a}}_{1} {a}_{4} {a}_{3} {\overline{a}}_{2} {\overline{a}}_{1} 000\end{matrix} ] , {S}_{1} = [ \begin{matrix}{S}_{11} \\ {S}_{12} \\ {S}_{13} \\ {S}_{14}\end{matrix} ] = [ \begin{matrix}{a}_{1} {a}_{2} {a}_{3} {a}_{4} {\overline{a}}_{1} {\overline{a}}_{2} {\overline{a}}_{3} {\overline{a}}_{4} 000 \\ {a}_{2} {\overline{a}}_{1} {a}_{4} {\overline{a}}_{3} {\overline{a}}_{2} {a}_{1} {\overline{a}}_{4} {a}_{3} 000 \\ {a}_{3} {\overline{a}}_{4} {\overline{a}}_{1} {a}_{2} {\overline{a}}_{3} {a}_{4} {a}_{1} {\overline{a}}_{2} 000 \\ {a}_{4} {a}_{3} {\overline{a}}_{2} {\overline{a}}_{1} {\overline{a}}_{4} {\overline{a}}_{3} {a}_{2} {a}_{1} 000\end{matrix} ]$$

$${C}_{2} = [ \begin{matrix}{C}_{21} \\ {C}_{22} \\ {C}_{23} \\ {C}_{24}\end{matrix} ] = [ \begin{matrix}{\overline{a}}_{1} {\overline{a}}_{2} {\overline{a}}_{3} {\overline{a}}_{4} {a}_{1} {a}_{2} {a}_{3} {a}_{4} 000 \\ {\overline{a}}_{2} {a}_{1} {\overline{a}}_{4} {a}_{3} {a}_{2} {\overline{a}}_{1} {a}_{4} {\overline{a}}_{3} 000 \\ {\overline{a}}_{3} {a}_{4} {a}_{1} {\overline{a}}_{2} {a}_{3} {\overline{a}}_{4} {\overline{a}}_{1} {a}_{2} 000 \\ {\overline{a}}_{4} {\overline{a}}_{3} {a}_{2} {a}_{1} {a}_{4} {a}_{3} {\overline{a}}_{2} {\overline{a}}_{1} 000\end{matrix} ] , {S}_{2} = [ \begin{matrix}{S}_{21} \\ {S}_{22} \\ {S}_{23} \\ {S}_{24}\end{matrix} ] = [ \begin{matrix}{\overline{a}}_{1} {\overline{a}}_{2} {\overline{a}}_{3} {\overline{a}}_{4} {\overline{a}}_{1} {\overline{a}}_{2} {\overline{a}}_{3} {\overline{a}}_{4} 000 \\ {\overline{a}}_{2} {a}_{1} {\overline{a}}_{4} {a}_{3} {\overline{a}}_{2} {a}_{1} {\overline{a}}_{4} {a}_{3} 000 \\ {\overline{a}}_{3} {a}_{4} {a}_{1} {\overline{a}}_{2} {\overline{a}}_{3} {a}_{4} {a}_{1} {\overline{a}}_{2} 000 \\ {\overline{a}}_{4} {\overline{a}}_{3} {a}_{2} {a}_{1} {\overline{a}}_{4} {\overline{a}}_{3} {a}_{2} {a}_{1} 000\end{matrix} ]$$

Because L=4, there zeros are inserted here. In the same way, autocorrelation and cross-correlation function of four pairs of code in (C₁, S₁) and (C₂, S₂) are not also ideal (shown in table 7 and table 8). But cross-correlation function of codes for different code group is completely ideal (table 9).

In this case, L=4, N=2, so as the “root” (see below) and the formation of the spread spectrum address code groups unilateral “window” width of the mouth Δ≧7.

TABLE 7
autocorrelation and cross-correlation function of (C₁, S₁)
${C}_{1} = [ \begin{matrix}{C}_{11} \\ {C}_{12} \\ {C}_{13} \\ {C}_{14}\end{matrix} ] = [ \begin{matrix}{a}_{1} {a}_{2} {a}_{3} {a}_{4} {a}_{1} {a}_{2} {a}_{3} {a}_{4} 000 \\ {a}_{2} {\overline{a}}_{1} {a}_{4} {\overline{a}}_{3} {a}_{2} {\overline{a}}_{1} {a}_{4} {\overline{a}}_{3} 000 \\ {a}_{3} {\overline{a}}_{4} {\overline{a}}_{1} {a}_{2} {a}_{3} {\overline{a}}_{4} {\overline{a}}_{1} {a}_{2} 000 \\ {a}_{4} {a}_{3} {\overline{a}}_{2} {\overline{a}}_{1} {a}_{4} {a}_{3} {\overline{a}}_{2} {\overline{a}}_{1} 000\end{matrix} ] , \\ {S}_{1} = [ \begin{matrix}{S}_{11} \\ {S}_{12} \\ {S}_{13} \\ {S}_{14}\end{matrix} ] = [ \begin{matrix}{a}_{1} {a}_{2} {a}_{3} {a}_{4} {\overline{a}}_{1} {\overline{a}}_{2} {\overline{a}}_{3} {\overline{a}}_{4} 000 \\ {a}_{2} {\overline{a}}_{1} {a}_{4} {\overline{a}}_{3} {\overline{a}}_{2} {a}_{1} {\overline{a}}_{4} {a}_{3} 000 \\ {a}_{3} {\overline{a}}_{4} {\overline{a}}_{1} {a}_{2} {\overline{a}}_{3} {a}_{4} {a}_{1} {\overline{a}}_{2} 000 \\ {a}_{4} {a}_{3} {\overline{a}}_{2} {\overline{a}}_{1} {\overline{a}}_{4} {\overline{a}}_{3} {a}_{2} {a}_{1} 000\end{matrix} ]$

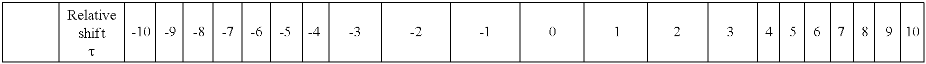

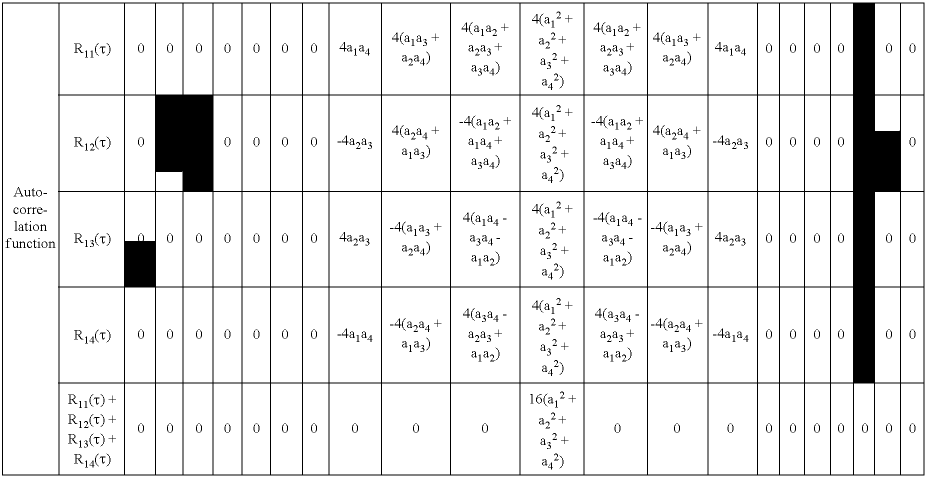

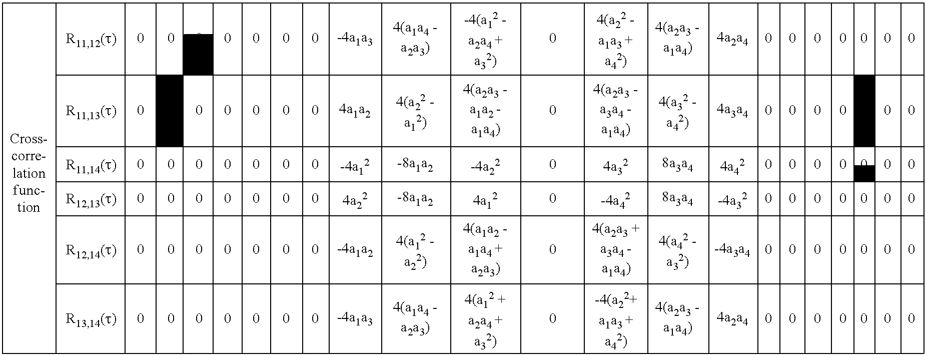

Annotations: The shading numbers don't appear in the structure codes of the spanning tree.

TABLE 8
the auto-correlation function and cross-correlation function of the (C₂, S₂) block
${C}_{2} = [ \begin{matrix}{C}_{21} \\ {C}_{22} \\ {C}_{23} \\ {C}_{24}\end{matrix} ] = [ \begin{matrix}{\overline{a}}_{1} {\overline{a}}_{2} {\overline{a}}_{3} {\overline{a}}_{4} {a}_{1} {a}_{2} {a}_{3} {a}_{4} 000 \\ {\overline{a}}_{2} {a}_{1} {\overline{a}}_{4} {a}_{3} {a}_{2} {\overline{a}}_{1} {a}_{4} {\overline{a}}_{3} 000 \\ {\overline{a}}_{3} {a}_{4} {a}_{1} {\overline{a}}_{2} {a}_{3} {\overline{a}}_{4} {\overline{a}}_{1} {a}_{2} 000 \\ {\overline{a}}_{4} {\overline{a}}_{3} {a}_{2} {a}_{1} {a}_{4} {a}_{3} {\overline{a}}_{2} {\overline{a}}_{1} 000\end{matrix} ] , \\ {S}_{2} = [ \begin{matrix}{S}_{21} \\ {S}_{22} \\ {S}_{23} \\ {S}_{24}\end{matrix} ] = [ \begin{matrix}{\overline{a}}_{1} {\overline{a}}_{2} {\overline{a}}_{3} {\overline{a}}_{4} {\overline{a}}_{1} {\overline{a}}_{2} {\overline{a}}_{3} {\overline{a}}_{4} 000 \\ {\overline{a}}_{2} {a}_{1} {\overline{a}}_{4} {a}_{3} {\overline{a}}_{2} {a}_{1} {\overline{a}}_{4} {a}_{3} 000 \\ {\overline{a}}_{3} {a}_{4} {a}_{1} {\overline{a}}_{2} {\overline{a}}_{3} {a}_{4} {a}_{1} {\overline{a}}_{2} 000 \\ {\overline{a}}_{4} {\overline{a}}_{3} {a}_{2} {a}_{1} {\overline{a}}_{4} {\overline{a}}_{3} {a}_{2} {a}_{1} 000\end{matrix} ]$

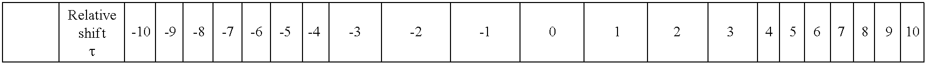

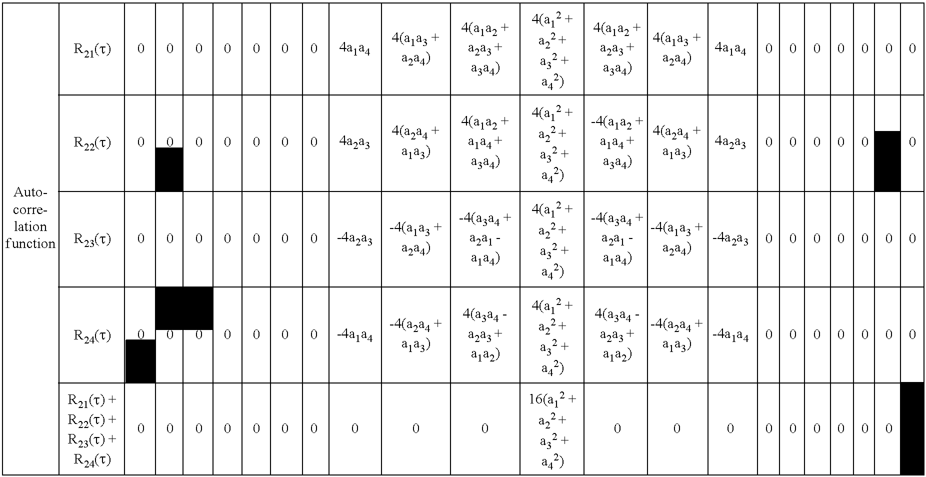

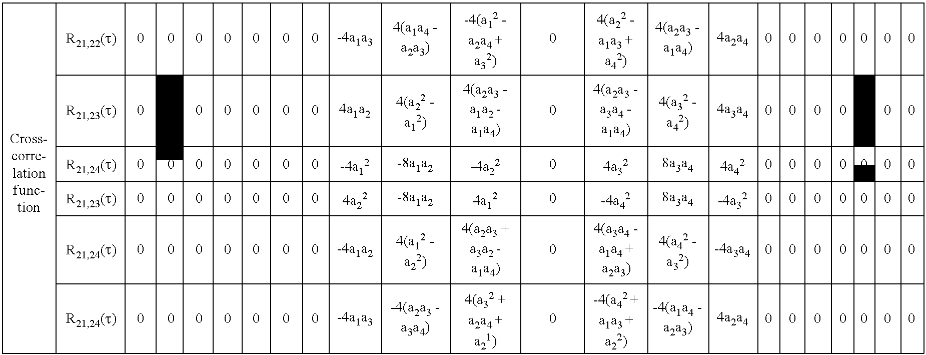

Annotations : The shading numbers don't appear in the structure codes of the spanning tree

TABLE 9
Cross-correlation functions between codes of different blocks in (C₁, S₁) and (C₂, S₂)
${C}_{1} = [ \begin{matrix}{C}_{11} \\ {C}_{12} \\ {C}_{13} \\ {C}_{14}\end{matrix} ] = [ \begin{matrix}{a}_{1} {a}_{2} {a}_{3} {a}_{4} {a}_{1} {a}_{2} {a}_{3} {a}_{4} 000 \\ {a}_{2} {\overline{a}}_{1} {a}_{4} {\overline{a}}_{3} {a}_{2} {\overline{a}}_{1} {a}_{4} {\overline{a}}_{3} 000 \\ {a}_{3} {\overline{a}}_{4} {\overline{a}}_{1} {a}_{2} {a}_{3} {\overline{a}}_{4} {\overline{a}}_{1} {a}_{2} 000 \\ {a}_{4} {a}_{3} {\overline{a}}_{2} {\overline{a}}_{1} {a}_{4} {a}_{3} {\overline{a}}_{2} {\overline{a}}_{1} 000\end{matrix} ] , \\ {S}_{1} = [ \begin{matrix}{S}_{11} \\ {S}_{12} \\ {S}_{13} \\ {S}_{14}\end{matrix} ] = [ \begin{matrix}{a}_{1} {a}_{2} {a}_{3} {a}_{4} {\overline{a}}_{1} {\overline{a}}_{2} {\overline{a}}_{3} {\overline{a}}_{4} 000 \\ {a}_{2} {\overline{a}}_{1} {a}_{4} {\overline{a}}_{3} {\overline{a}}_{2} {a}_{1} {\overline{a}}_{4} {a}_{3} 000 \\ {a}_{3} {\overline{a}}_{4} {\overline{a}}_{1} {a}_{2} {\overline{a}}_{3} {a}_{4} {a}_{1} {\overline{a}}_{2} 000 \\ {a}_{4} {a}_{3} {\overline{a}}_{2} {\overline{a}}_{1} {\overline{a}}_{4} {\overline{a}}_{3} {a}_{2} {a}_{1} 000\end{matrix} ]$ ${C}_{2} = [ \begin{matrix}{C}_{21} \\ {C}_{22} \\ {C}_{23} \\ {C}_{24}\end{matrix} ] = [ \begin{matrix}{\overline{a}}_{1} {\overline{a}}_{2} {\overline{a}}_{3} {\overline{a}}_{4} {a}_{1} {a}_{2} {a}_{3} {a}_{4} 000 \\ {\overline{a}}_{2} {a}_{1} {\overline{a}}_{4} {a}_{3} {a}_{2} {\overline{a}}_{1} {a}_{4} {\overline{a}}_{3} 000 \\ {\overline{a}}_{3} {a}_{4} {a}_{1} {\overline{a}}_{2} {a}_{3} {\overline{a}}_{4} {\overline{a}}_{1} {a}_{2} 000 \\ {\overline{a}}_{4} {\overline{a}}_{3} {a}_{2} {a}_{1} {a}_{4} {a}_{3} {\overline{a}}_{2} {\overline{a}}_{1} 000\end{matrix} ] , \\ {S}_{2} = [ \begin{matrix}{S}_{21} \\ {S}_{22} \\ {S}_{23} \\ {S}_{24}\end{matrix} ] = [ \begin{matrix}{\overline{a}}_{1} {\overline{a}}_{2} {\overline{a}}_{3} {\overline{a}}_{4} {\overline{a}}_{1} {\overline{a}}_{2} {\overline{a}}_{3} {\overline{a}}_{4} 000 \\ {\overline{a}}_{2} {a}_{1} {\overline{a}}_{4} {a}_{3} {\overline{a}}_{2} {a}_{1} {\overline{a}}_{4} {a}_{3} 000 \\ {\overline{a}}_{3} {a}_{4} {a}_{1} {\overline{a}}_{2} {\overline{a}}_{3} {a}_{4} {a}_{1} {\overline{a}}_{2} 000 \\ {\overline{a}}_{4} {\overline{a}}_{3} {a}_{2} {a}_{1} {\overline{a}}_{4} {\overline{a}}_{3} {a}_{2} {a}_{1} 000\end{matrix} ]$

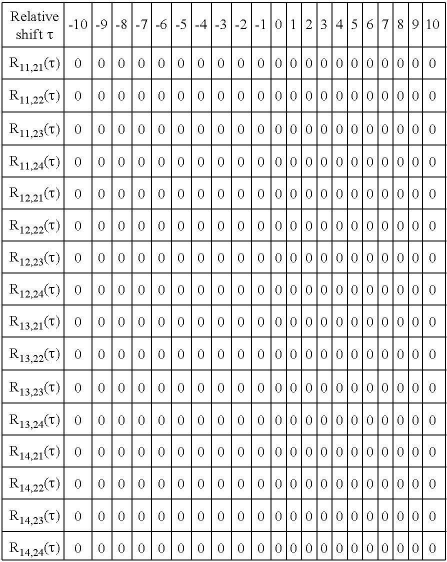

Annotations: The shading numbers don't appear in the structure codes of the spanning tree.

Step 4:

According to the spanning tree method, we extend the length and number of the basic perfect complementary orthogonal code pairs mate. Among groups of the extending address codes, if elements of the basic codes expanding matrix is made up of “weak” correlation diversity random variables, the matrix will have the corresponding order of hidden diversities with the kind and number of random variables, as well, the cross-correlation function of address codes in different blocks has a “zero correlation window” around the origin point, the width of the “window” is determined by the basic length of the perfect complementary orthogonal code pairs mate.

If (C₁, S₁) and (C₂, S₂) is one basic perfect complementary orthogonal code pairs mate, the basic operation of extending code length and code number is as follows,

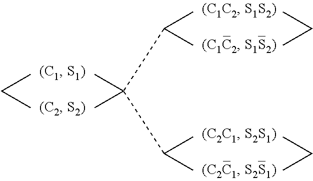

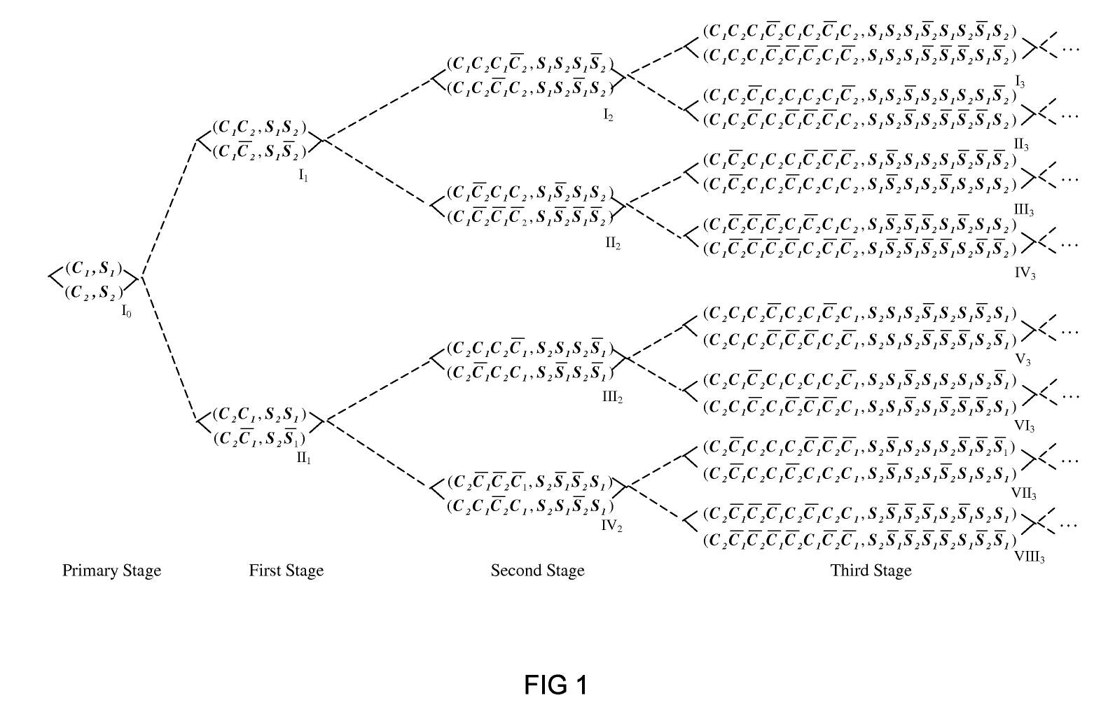

The newborn (C₁C₂, S₁S₂), (C₁ C̅₂, S₁ S̅₂), (C₂C₁, S₂S₁) and (C₂ C̅₁, S₂ S̅₁) are respectively two new perfect complementary orthogonal code pairs mates with the code length doubling, but the cross-correlation function of the code pair mate will not be perfect, only has the characteristic of “zero correlation window”, if we continuously do the extending operation above, the tree view structure chart of FIG. 1 will be formed.

In the root part, namely the initial zero stage, we only have one perfect complementary orthogonal code pairs mate, there are two groups of codes in all. At the first stage, we can obtain two perfect complementary orthogonal code pairs mates, four groups of codes altogether, the code length is 2¹=2 times the code length of the initial stage, the cross-correlation function of the mate is ideal, but the cross-correlation function between two different mates have the characteristic of “zero correlation window”. At the second stage, we can get four code pairs mates, eight groups of codes, the code length is 2²=4 times the code length of the initial stage, generally speaking, continuously do the extending like this, at the lth stage 2^{l} code pair mates and 2^{l+1} groups of codes in total are available, the code length is 2^{l} times that of the initial stage. At every stage of extending, each code pair mate is perfect complementary orthogonal code pairs mate, the cross-correlation function of codes of the same mate is ideal, the cross-correlation function of codes of different mates has the characteristic of “zero correlation window”, its single side width of the “window” is not less than the code length of the codes of the same “root” between the two mates minus one. For instance, in the FIG. 1, the single side width of the “window” of the cross-correlation function between the codes among I₂ and II₂ is not less than the basic code length of I₁ minus one, as I₁ is the same “root” between I₂ and II₂. Similarly, the single side width of the “window” of the cross-correlation function between the codes among III₂ and IV₂ is not less than the basic code length of II₁ minus one, since II₁ is the same “root” between III₂ and IV₂. But the single side width of the “window” of the cross-correlation function between the codes among I₂, III₂ and IV₂ can only be not less than the basic code length of I₀ (namely the initial root) minus one, because only the initial root is their common root. So-called “basic code length” refers to the length of the code, not containing the last element 0 but the element 0 intermediate.

What needs to be explained specially is that, the basic codes expanding matrix used in this invention maybe some random matrix. Only at the base station side can one expanding matrix be used by clients with different address, the clients at the different mobile stations, when the basic codes expanding matrix is a random matrix, it is impossible to use the same codes expanding matrix. On condition that the expanding matrix is different, can we still assure the “zero correlation window” characteristic of the cross-correlation function between code pair mates? The answer is positive. Theory and practice both have proved that, as long as the expanding matrices used by the address codes of the users are isomorphic matrices, the “zero correlation function” and other characteristics of the address codes generated by the spanning tree will be reserved instead of being destroyed; the so-called isomorphic matrices refer to the matrices having the same structural form, whereas the elements of the matrices don't need to be the same, for example,

$$[ \begin{matrix}{a}_{1} & {a}_{2} \\ {a}_{2} & {\overline{a}}_{1}\end{matrix} ] and [ \begin{matrix}{b}_{1} & {b}_{2} \\ {b}_{2} & {\overline{b}}_{1}\end{matrix} ]$$

are isomorphic matrices, elements a₁, a₂ and b₁, b₂ can be quite different, as another example,

$$[ \begin{matrix}{a}_{1} & {a}_{2} & {a}_{3} & {a}_{4} \\ {a}_{2} & {\overline{a}}_{1} & {a}_{4} & {\overline{a}}_{3} \\ {a}_{3} & {\overline{a}}_{4} & {\overline{a}}_{1} & {a}_{2} \\ {a}_{4} & {a}_{3} & {\overline{a}}_{2} & {\overline{a}}_{1}\end{matrix} ] and [ \begin{matrix}{b}_{1} & {b}_{2} & {b}_{3} & {b}_{4} \\ {b}_{2} & {\overline{b}}_{1} & {b}_{4} & {\overline{b}}_{3} \\ {b}_{3} & {\overline{b}}_{4} & {\overline{b}}_{1} & {b}_{2} \\ {b}_{4} & {b}_{3} & {\overline{b}}_{2} & {\overline{b}}_{1}\end{matrix} ]$$

are also isomorphic matrices, elements a₁, a₂, a₃, a₄ and b₁, b₂, b₃, b₄ can have nothing to do with each other.

Therefore, at every stage of the spanning tree in FIG. 1, different “rows”, namely the codes expanding matrix of different blocks, can be the same matrix (for instance used in the base station), also can be isomorphic matrix (for example applied in the mobile station), whatever the case maybe, we must assure the codes expanding matrix of the same “row” (namely the same block) is the same matrix.

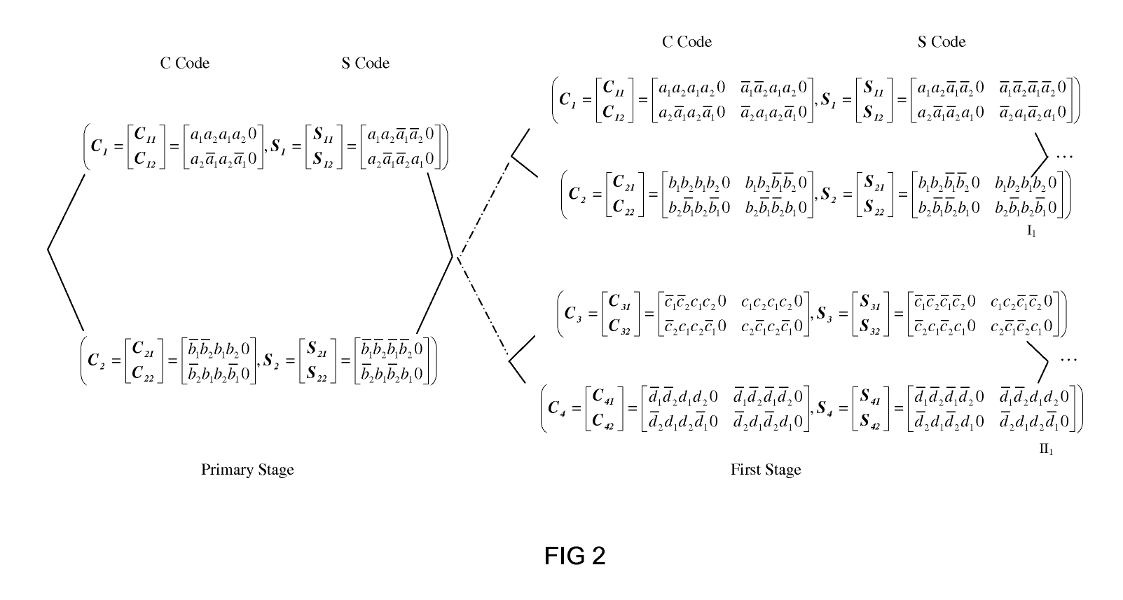

FIG. 2 is a specific example of codes spanning tree, in order to make it concise, only two stages of the spanning tree are described. The basic complementary orthogonal code pair mate used in this figure is:

[symbol] =++, [symbol] =+−;

[symbol] =−+, [symbol] =−−_{°}

The basic codes expanding matrix

$$A = [ \begin{matrix}{a}_{1} & {a}_{2} \\ {a}_{2} & {\overline{a}}_{1}\end{matrix} ] .$$

Each “row” in FIG. 2, that is, the code expanding matrices of different blocks is all expressed as isomorphic matrices. After applying the isomorphic code expanding matrices, let us take the case of former example 1 (namely the FIG. 2 spanning tree) to explain, at the first stage, it generates two mates (C₁,S₁), (C₂,S₂) and (C₃,S₃), (C₄,S₄), as has been stated, (C₁,S₁), (C₂,S₂) and (C₃,S₃) (C₄,S₄) should be perfect complementary orthogonal code pair mate, that is, the cross-correlation functions between the codes of different blocks in each mate should be ideal, and the cross-correlation functions between the codes of different mates should have the characteristic of “zero correlation window”. Table 10 to Table 13 are auto-correlation functions and cross-correlation functions between different blocks, Table 14 is auto-correlation functions between different codes of different blocks. Because in this example, the length of basic perfect complementary orthogonal code pair mate N=2, the number of columns of the code expanding matrix L=2, so the width of single side “window” should not be less than NL−1=2×2−1=3 times the width of the chip.

(Table 10 to Table 14 as follows)

TABLE 10
FIG. 2 Autocorrelation and Cross-correlation function of group code
(C₁, S₁) in the first phase

| | The relative | | | | | | | | | | | | | | | | | | | |
|---|---|---|---|---|---|---|---|---|---|---|---|---|---|---|---|---|---|---|---|---|
| | shift τ | −9 | −8 | −7 | −6 | −5 | −4 | −3 | −2 | −1 | 0 | 1 | 2 | 3 | 4 | 5 | 6 | 7 | 8 | 9 |
| Autocorrelation | R₁₁(τ) | 0 | 0 | 0 | 0 | 0 | 0 | 0 | 0 | 8a₁a₂ | 8(a₁² + a₂²) | 8a₁a₂ | 0 | 0 | 0 | 0 | 0 | 0 | 0 | 0 |
| function | R₁₂(τ) | 0 | 0 | 0 | 0 | 0 | 0 | 0 | 0 | −8a₁a₂ | 8(a₁² + a₂²) | −8a₁a₂ | 0 | 0 | 0 | 0 | 0 | 0 | 0 | 0 |
| | R₁₁(τ) + R₁₂( τ) | 0 | 0 | 0 | 0 | 0 | 0 | 0 | 0 | 0 | 16(a₁² + a₂²) | 0 | 0 | 0 | 0 | 0 | 0 | 0 | 0 | 0 |
| Cross-correlation | R_{11, 12}(τ) | 0 | 0 | 0 | 0 | 0 | 0 | 0 | 0 | −8a₁² | 0 | 8a₂² | 0 | 0 | 0 | 0 | 0 | 0 | 0 | 0 |
| function | | | | | | | | | | | | | | | | | | | | |

TABLE 11
FIG. 2 Autocorrelation and Cross-correlation function of group code
(C₂, S₂) in the first phase

| | The relative | | | | | | | | | | | | | | | | | | | |
|---|---|---|---|---|---|---|---|---|---|---|---|---|---|---|---|---|---|---|---|---|
| | shift τ | −9 | −8 | −7 | −6 | −5 | −4 | −3 | −2 | −1 | 0 | 1 | 2 | 3 | 4 | 5 | 6 | 7 | 8 | 9 |
| Autocorrelation | R₂₁(τ) | 0 | 0 | 0 | 0 | 0 | 0 | 0 | 0 | 8b₁b₂ | 8(b₁² + b₂²) | 8b₁b₂ | 0 | 0 | 0 | 0 | 0 | 0 | 0 | 0 |
| function | R₂₂(τ) | 0 | 0 | 0 | 0 | 0 | 0 | 0 | 0 | −8b₁b₂ | 8(b₁² + b₂²) | −8b₁b₂ | 0 | 0 | 0 | 0 | 0 | 0 | 0 | 0 |
| | R₂₁(τ) + R₂₂( τ) | 0 | 0 | 0 | 0 | 0 | 0 | 0 | 0 | 0 | 16(b₁² + b₂²) | 0 | 0 | 0 | 0 | 0 | 0 | 0 | 0 | 0 |
| Cross-correlation | R_{21, 22}(τ) | 0 | 0 | 0 | 0 | 0 | 0 | 0 | 0 | −8b₁² | 0 | 8b₂² | 0 | 0 | 0 | 0 | 0 | 0 | 0 | 0 |
| function | | | | | | | | | | | | | | | | | | | | |

TABLE 12
FIG. 2 Autocorrelation and Cross-correlation function of group code
(C₃, S₃) in the first phase

| | The relative | | | | | | | | | | | | | | | | | | | |
|---|---|---|---|---|---|---|---|---|---|---|---|---|---|---|---|---|---|---|---|---|
| | shift τ | −9 | −8 | −7 | −6 | −5 | −4 | −3 | −2 | −1 | 0 | 1 | 2 | 3 | 4 | 5 | 6 | 7 | 8 | 9 |
| Autocorrelation | R₃₁(τ) | 0 | 0 | 0 | 0 | 0 | 0 | 0 | 0 | 8c₁c₂ | 8(c₁² + c₂²) | 8c₁c₂ | 0 | 0 | 0 | 0 | 0 | 0 | 0 | 0 |
| function | R₃₂(τ) | 0 | 0 | 0 | 0 | 0 | 0 | 0 | 0 | −8c₁c₂ | 8(c₁² + c₂²) | −8c₁c₂ | 0 | 0 | 0 | 0 | 0 | 0 | 0 | 0 |
| | R₃₁(τ) + R₃₂( τ) | 0 | 0 | 0 | 0 | 0 | 0 | 0 | 0 | 0 | 16(c₁² + c₂²) | 0 | 0 | 0 | 0 | 0 | 0 | 0 | 0 | 0 |
| Cross-correlation | R_{31, 32}(τ) | 0 | 0 | 0 | 0 | 0 | 0 | 0 | 0 | −8c₁² | 0 | 8c₂² | 0 | 0 | 0 | 0 | 0 | 0 | 0 | 0 |
| function | | | | | | | | | | | | | | | | | | | | |

TABLE 13
FIG. 2 Autocorrelation and Cross-correlation function of group code
(C₄, S₄) in the first phase

| | The relative | | | | | | | | | | | | | | | | | | | |
|---|---|---|---|---|---|---|---|---|---|---|---|---|---|---|---|---|---|---|---|---|
| | shift τ | −9 | −8 | −7 | −6 | −5 | −4 | −3 | −2 | −1 | 0 | 1 | 2 | 3 | 4 | 5 | 6 | 7 | 8 | 9 |
| Autocorrelation | R₄₁(τ) | 0 | 0 | 0 | 0 | 0 | 0 | 0 | 0 | 8d₁d₂ | 8(d₁² + d₂²) | 8d₁d₂ | 0 | 0 | 0 | 0 | 0 | 0 | 0 | 0 |
| function | R₄₂(τ) | 0 | 0 | 0 | 0 | 0 | 0 | 0 | 0 | −8d₁d₂ | 8(d₁² + d₂²) | −8d₁d₂ | 0 | 0 | 0 | 0 | 0 | 0 | 0 | 0 |
| | R₄₁(τ) + R₄₂( τ) | 0 | 0 | 0 | 0 | 0 | 0 | 0 | 0 | 0 | 16(d₁² + d₂²) | 0 | 0 | 0 | 0 | 0 | 0 | 0 | 0 | 0 |
| Cross-correlation | R_{41, 42}(τ) | 0 | 0 | 0 | 0 | 0 | 0 | 0 | 0 | −8d₁² | 0 | 8d₂² | 0 | 0 | 0 | 0 | 0 | 0 | 0 | 0 |
| function | | | | | | | | | | | | | | | | | | | | |

TABLE 14
The first phase of the code in different groups of the code
cross-correlation function of FIG. 2

| relative | | | | | | | | | | | | | | | | | | | |
|---|---|---|---|---|---|---|---|---|---|---|---|---|---|---|---|---|---|---|---|
| shift τ | −9 | −8 | −7 | −6 | −5 | −4 | −3 | −2 | −1 | 0 | 1 | 2 | 3 | 4 | 5 | 6 | 7 | 8 | 9 |
| R_{11, 21}(τ) | 0 | 0 | 0 | 0 | 0 | 0 | 0 | 0 | 0 | 0 | 0 | 0 | 0 | 0 | 0 | 0 | 0 | 0 | 0 |
| R_{11, 22}(τ) | 0 | 0 | 0 | 0 | 0 | 0 | 0 | 0 | 0 | 0 | 0 | 0 | 0 | 0 | 0 | 0 | 0 | 0 | 0 |
| R_{11, 31}(τ) | 0 | 0 | 0 | 4a₁c₂ | 4a₁c₁ | 4a₂c₁ | 0 | 0 | 0 | 0 | 0 | 0 | 0 | 4a₁c₂ | 4a₁c₁ | 4a₂c₁ | 0 | 0 | 0 |
| | | | | | +4a₂c₂ | | | | | | | | | | +4a₂c₂ | | | | |
| R_{11, 32}(τ) | 0 | 0 | 0 | −4a₁c₁ | 4a₁c₂ | 4a₂c₂ | 0 | 0 | 0 | 0 | 0 | 0 | 0 | −4a₁c₁ | 4a₁c₂ | 4a₂c₂ | 0 | 0 | 0 |
| | | | | | −4a₂c₁ | | | | | | | | | | −4a₂c₁ | | | | |
| R_{11, 41}(τ) | 0 | 0 | 0 | −4a₁d₂ | −4a₁d₁ | −4a₂d₁ | 0 | 0 | 0 | 0 | 0 | 0 | 0 | 4a₁d₂ | 4a₁d₁ | 4a₂d₁ | 0 | 0 | 0 |
| | | | | | −4a₂d₂ | | | | | | | | | | +4a₂d₂ | | | | |
| R_{11, 42}(τ) | 0 | 0 | 0 | 4a₁d₁ | 4a₂d₁ | −4a₂d₂ | 0 | 0 | 0 | 0 | 0 | 0 | 0 | −4a₁d₁ | 4a₂d₁ | 4a₂d₂ | 0 | 0 | 0 |
| | | | | | −4a₁d₂ | | | | | | | | | | −4a₁d₂ | | | | |
| R_{12, 21}(τ) | 0 | 0 | 0 | 0 | 0 | 0 | 0 | 0 | 0 | 0 | 0 | 0 | 0 | 0 | 0 | 0 | 0 | 0 | 0 |
| R_{12, 22}(τ) | 0 | 0 | 0 | 0 | 0 | 0 | 0 | 0 | 0 | 0 | 0 | 0 | 0 | 0 | 0 | 0 | 0 | 0 | 0 |
| R_{12, 31}(τ) | 0 | 0 | 0 | 4a₂c₂ | 4a₂c₁ | −4a₁c₁ | 0 | 0 | 0 | 0 | 0 | 0 | 0 | 4a₂c₂ | 4a₂c₁ | −4a₁c₁ | 0 | 0 | 0 |
| | | | | | −4a₁c₂ | | | | | | | | | | −4a₁c₂ | | | | |
| R_{12, 32}(τ) | 0 | 0 | 0 | −4a₂c₁ | 4a₂c₂ | −4a₁c₂ | 0 | 0 | 0 | 0 | 0 | 0 | 0 | −4a₂c₁ | 4a₂c₂ | −4a₁c₂ | 0 | 0 | 0 |
| | | | | | +4a₁c₁ | | | | | | | | | | +4a₁c₁ | | | | |
| R_{12, 41}(τ) | 0 | 0 | 0 | −4a₂d₂ | −4a₁d₂ | 4a₁d₁ | 0 | 0 | 0 | 0 | 0 | 0 | 0 | 4a₂d₂ | 4a₂d₁ | −4a₁d₁ | 0 | 0 | 0 |
| | | | | | −4a₂d₁ | | | | | | | | | | −4a₁d₂ | | | | |
| R_{12, 42}(τ) | 0 | 0 | 0 | 4a₂d₁ | −4a₂d₂ | 4a₁d₂ | 0 | 0 | 0 | 0 | 0 | 0 | 0 | −4a₂d₁ | 4a₂d₂ | −4a₁d₂ | 0 | 0 | 0 |
| | | | | | −4a₁d₁ | | | | | | | | | | +4a₁d₁ | | | | |
| R_{21, 31}(τ) | 0 | 0 | 0 | 4b₁c₂ | 4b₁c₁ | 4b₂c₁ | 0 | 0 | 0 | 0 | 0 | 0 | 0 | −4b₁c₂ | −4b₁c₁ | −4b₂c₁ | 0 | 0 | 0 |
| | | | | | +4b₂c₂ | | | | | | | | | | −4b₂c₂ | | | | |
| R_{21, 32}(τ) | 0 | 0 | 0 | −4b₁c₁ | 4b₁c₂ | 4b₂c₂ | 0 | 0 | 0 | 0 | 0 | 0 | 0 | 4b₁c₁ | −4b₁c₂ | −4b₂c₂ | 0 | 0 | 0 |
| | | | | | −4b₂c₁ | | | | | | | | | | +4b₂c₁ | | | | |
| R_{21, 41}(τ) | 0 | 0 | 0 | −4b₁d₂ | −4b₁d₁ | 4b₂d₁ | 0 | 0 | 0 | 0 | 0 | 0 | 0 | −4b₁d₂ | −4b₁d₁ | −4b₂d₁ | 0 | 0 | 0 |
| | | | | | −4b₂d₂ | | | | | | | | | | −4b₂d₂ | | | | |
| R_{21, 42}(τ) | 0 | 0 | 0 | 4b₁d₁ | −4b₁d₂ | −4b₂d₂ | 0 | 0 | 0 | 0 | 0 | 0 | 0 | 4b₁d₁ | −4b₁d₂ | −4b₂d₂ | 0 | 0 | 0 |
| | | | | | +4b₂d₁ | | | | | | | | | | +4b₂d₁ | | | | |

Comparing Table 14 to coding method in PCT/CN00/0028, it can be found that even if the use of such a simple coding expansion matrix under the conditions of the same cross-correlation function “window”, the code number provided by the present invention addresses has doubled, which of course is at the expense of the “zero correlation window” features of the group address code, while the code length also increase a little by 25%. The reason for the increase of the code length is that the codes must be isolated in the two adjacent generating units in the spanning tree, so that they do not interfere with each other. In the use of more complex coding expansion matrix, the using of the present invention of addresses coding technology, the spectrum efficiency and “window” width of the WCS will be further raised.

In short, the basic perfect complementary code pairs mate of the initial “root” of the spanning tree can totally determine the nature of the code generated by the expansion of the spanning tree such as:

1) In the l (l=0, 1, 2, . . . ) phase of the tree, there are a total of 2^{(l+1)} group of codes and there are M codes in each group, where M is the rows of the coding expansion matrix. The length of the code of each group is (NL+L−1)×2^{l}, where N means the length of the basic orthogonal complementary code pairs mate, L is the row of the coding expansion matrix.

2) The cross-correlation function between the address code in different code groups, not only exists a “zero correlation window” in the vicinity of the origin, but also exists a series of “zero correlation window” beside the origin whose width is the same as the “zero correlation window” in the vicinity of the origin, That is, the width is not narrow than twice of the basic length of the common “root” minus one. In the “zero correlation window”, there may be some correlated vice peaks, the number of which is not more than twice the number of the columns (L) of the coding expansion matrix minus one (that is 2L−1).

3) The hidden diversity multiplicity of the address code itself equals to the number of the weak correlated random variables in the corresponding row of the coding expansion matrix. Its maximum value of the row is L in the coding expansion matrix. The largest multiplicity of the hidden diversity of the actual factor equals to L multiplies the time spread capacity of actual channel which uses the chip as the unit.

Step Five: The Transformation of the Spanning Tree

FIG. 1 shows only the most basic spanning tree. There are many types of spanning tree, but they are mathematically equivalent. The transformation of the spanning tree can produce a huge number of variants of the address code group, which will bring a lot of practical convenience for the projects, because the code groups generated by the code through the transformation often have many new and even the wonderful nature, which can adapt to the needs of different projects, such as the network needs, switch needs as well as the need to expand the capacity. Some of the major transformation list as follows:

Exchange the location of C code and S code in the spanning tree;

One of the S code or C code will take the anti-check form, or both at the same time taking the anti-check form;

Using the inverted sequences, C code and S code will take the inverted sequence at the same time;

Interlacing the polarity of each code bit, such as maintaining the odd bit, then taking the anti-check form of the even bit, on the contrary, maintaining the even bit, then taking the anti-check form of the odd bit;

Uniformly rotating each code bit in the complex plane. For example, C code for aC₁ C₂ C₃ C₄ C₅, if each rotating 72°, that is, uniform rotation for the one-week transformation is C₁exp(jξ₀), C₂exp[j(ξ₀+72°)], C₃exp[j(ξ₀+144°)], C₄exp[j(ξ₀+216°)], C₅exp[j(ξ₀+288°)]; if each rotating 144°, that is, uniform rotation for the two-week transformation is C₁exp(jξ₁), C₂exp[j(ξ₁+144°)], C₃exp[j(ξ₁+288°)], C₄exp[j(ξ₁+72°)], C₅exp[j(ξ₁+216°)]; if each rotating 216°, that is, the uniform rotation for the three-week transformation is C₁exp(jξ₂), C₂exp[j(ξ₂+216°)], C₃exp[j(ξ₂+72°)], C₄exp[j(ξ₂+288°)], C₅exp[j(ξ₂+144°)]; if each rotating 288°, that is uniform rotation for the four-week transformation is C₁exp(jξ₃), C₂exp[j(ξ₃+288°)], C₃exp[j(ξ₃+216°)], C₄exp[j(ξ₃+144°)], C₅exp[j(ξ₃+72°)]; among this, ξ₀, ξ₁, ξ₂, ξ₃ is any angle of the initial, S code corresponding to C code should be in the same rotation, however, the initial angle may be different from C code. described above is the whole spin cycle, non-integer spin cycle is in fact possible, as long as C code and corresponding S code is of the same rotation. After the rotation by the transformation, the location of “zero window” and the vice peak of the related functions won't be changed, however, the polarity and size of vice-peak-related associated with the rotation angle.

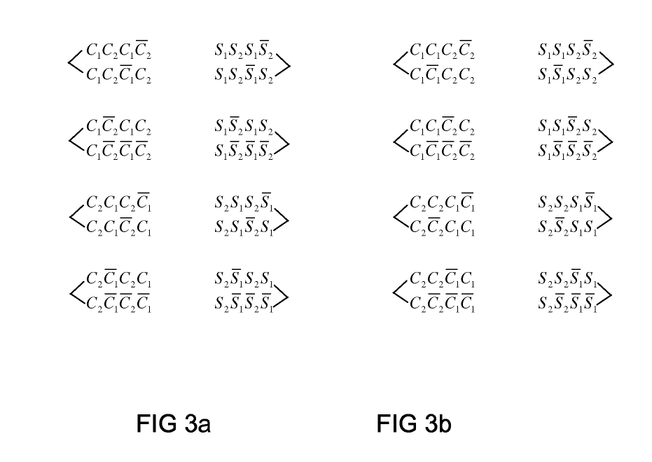

Synchronous rearranged each “row” of C code and S code in the spanning tree, the “row” is a perfect orthogonal complementary code pairs mate in the code for the unit. For example, in FIG. 1, C code and S code of the basic spanning tree in the third phase has four rows, if swapping row 2 and row 3 of C and S code, a new code group can be gotten, as shown in FIG. 3b.

Under normal circumstances, if C(s) code has p “row” in the spanning tree at some stage, then the transform order may have p! kinds.

A number of fundamental transformations are listed above, and there are many transformation which can proceed separately, continuously, even jointly. Due to there are many types of transformation, the number of the code group generated by the project through the transformation for the practical application will be tremendous, which is precisely the important feature of using the invention of the WCS.

In the project practice, the use of the invention of the WCS must ensure that only C code computes with code C (including their own and others), and S code with S code (including their own and others). Generally C and S code does not allow to meet, and the project should be adopted special measures to quarantine, For example, in the dissemination of certain conditions, if the spread of the two polarized electromagnetic waves are synchronized decline, C and S code may be modulated respectively in each of the two orthogonal polarized wave (Horizontal and vertical polarization wave, with the L-d-wave polarization); In another example, when the fading of the channel remains unchanged in two or more code length, C and S code can be placed separately in two non-overlapped slot after transmission. In order to ensure the complement, C and S code must decline synchronously and not allowed to “meet” during the transmission. These are two of the most basic requirements, of course, the information symbols modulated in the C code and S code must also be the same.

One of the important features of the present invention is, while improving the system of hidden diversity multiplicity, the spectrum efficiency of the system will not be reduced, but improved! This is the main advantage of the “group” encoding technology, and diversity-related concepts so-called diversity-related, as the name suggests is the decline between the “channels” is related, in other words, it allow some overlap between the “channels”, in which way a given channel “space” and the system parameters, the “multiplicity” of possible diversity will be increased, generally speaking, diversity related have poor performance than diversity unrelated in the same “multiplicity”, However, theory and experiment have shown that, as long as the correlation coefficient is not very big, for example less than e⁻¹≅0.37, or even equals to 0.5, diversity-related “multiplicity” may be about to double. but by over reducing the requirements of correlation as to enhance the diversity multiplicity is undesirable, on the one hand, because doing so would greatly increase the complexity of the system, at the same time, practical and effective diversity “multiplicity” will be an increase in the number getting smaller and smaller, therefore, this approach must be appropriate.

The present invention provides a multi-address coding technology in a CDMA system and other wireless communication systems. Different from traditional address coding technology, where the elements (chip) of address code are fixed binary value (or ten), multiple or complex numerical value, the address code elements (chip) used in the present invention is not necessarily a fixed value and may be a number of random variables, or rather a number of different “channel” generated randomly ups and downs after the transfer of the decline of variables. Due to the decline only exists in three types of, time, frequency, and space, the present invention address coding is also called time and space, frequency address coding.

The effectiveness of the present invention is the existence of “zero correlation window.” in cross-correlation function between groups of different address coding. Some code constitute a group address code, correlation and cross correlation function of the code within the groups does not require a “zero correlation window” characteristics. Rely on the method of the present invention under the same “window” width conditions, the present invention can provide more address code. On the contrary, under the equal number of addresses code conditions, the present invention can provide a broader “window”, for a more substantial increase the capacity of the system and created conditions for the efficiency of spectrum. So that the present invention for the address of the code at the same time have high transmission reliability, that is, have high hidden diversity multiplicity, and an increase in the number of hidden diversity multiplicity, the system spectrum efficiency will increase or remain the same. Since the invention of address requests each user a set of code, Although the correlation function and cross-correlation function between different codes of the group is not ideal, however, due to the group code is used by the user, channel fading in exactly the same. At the same time, the number of group code is a limited number of fixed. This will bring convenience for joint code detection, and solve problem of joint detection complexity in traditional CDMA systems.

The Code Division Multiple Address (CDMA) Mobile Digital Communications of the present invention is not meant to be limited to the aforementioned system prototype, and the subsequence specific description utilization and explanation of certain characteristics previously recited as being characteristics of this prototype implementation are not intended to be limited to such technologies.

Since many modifications, variations and changes in detail can made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

1. A new code division multiple address coding method related random variables or some constants such as time, space and frequency as the coding elements, said method comprising:
a) Selecting the basic orthogonal perfect complementary code pairs mate,
b) Selecting the basic time, space and frequency coding expansion matrix,
c) Constituting a perfect orthogonal complementary code pairs mate group,
d) Expanding the length and the number of the code group in accordance with the law of spanning tree, and
e) Completing the coding by transforming the spanning tree.

2. The method as recited in claim 1 wherein selecting said basic orthogonal perfect complementary code pairs mate comprising:
a) Determining the length N of the basic orthogonal perfect complementary code pairs mate in accordance with the requirements of the required width of the zero correlation window and the code number within the code group,
b) Determining the length of a minimum basic perfect complementary code N0 according to the relational expression N=N₀×2^{l}; l=0, 1, 2, . . . ,
c) Selecting the code [symbol] with the minimum code length, where [symbol] =[C₁₁, C₁₂, . . . C_{1N}_{₀}] in accordance with the minimum code length obtained by the above steps and the requirements of the project implementation,
d) Solving the code [symbol] which is fully complementary with the code [symbol] can be solved by working out the simultaneous equations system mathematically,
where [symbol] =[S₁₁, S₁₂, . . . S_{1N}_{₀}], according to the fully complementary requirements of the autocorrelation function,
e) Solving another minimum basic complementary code ( [symbol] ) which is totally orthogonally complementary to said ( [symbol] ) based on said minimum basic complementary code ( [symbol] ) solved by said above steps, and
f) Forming the perfect orthogonal complementary code pairs mate with the required length of N=N₀×2^{l} (l=0, 1, 2, . . . ) from the perfect orthogonal complementary code pairs mate with the length of N0.

3. The method as recited in claim 1 wherein selecting said basic orthogonal perfect complementary code pairs mate comprising:
a) Determining the length N of said basic orthogonal perfect complementary code pairs mate in accordance with the requirements of the required width of the zero correlation window and the code number within the code group,
b) Determining the length of two minimum basic perfect complementary codes N01, N02 according to the relation N=N₀₁×N₀₂×2^{l+1}; l=0, 1, 2, . . . ,
c) Selecting the code [symbol] with the minimum code length, where [symbol] =[C₁₁, C₁₂, . . . C_{1N}_{₀}] in accordance with the minimum code length decided by above said steps and the requirements of the project implementation,
d) Solving the code [symbol] which is fully complementary with said code [symbol] by working out the simultaneous equations system mathematically, where [symbol] =[S₁₁, S₁₂, . . . S_{1N}_{₀}], according to the fully complementary requirements of the autocorrelation function,
e) Solving said two pairs of ( [symbol] ) and ( [symbol] ) by repeating said above steps,
f) Solving another minimum basic complementary code ( [symbol] ) which is totally orthogonally complementary to said ( [symbol] ) based on the minimum basic complementary code ( [symbol] ) solved by above said steps, and
g) Forming the perfect orthogonal complementary code pairs mate with the required length of N=N₀×2^{l} (l=0, 1, 2, . . . ) from the perfect orthogonal complementary code pairs mate with the length of N0.

4. The method as recited in claim 2 wherein said length of the new perfect orthogonal complementary code pairs mate can be doubled by coupling the short code in the following steps:
C₁= [symbol] ; S₁= [symbol]
C₂= [symbol] ; S₁= [symbol] _{°}

5. The method as recited in claim 2 wherein said length of the new perfect orthogonal complementary code pairs mate can be doubled in the following steps:
The parity bits of said code C₁(S₁) composed of [symbol] and [symbol] respectively and
the parity bits of said code C₂(S₂) composed of [symbol] and [symbol] respectively.

6. The method as recited in claim 2 wherein said length of the new perfect orthogonal complementary code pairs mate can be doubled by coupling the short code in the following steps:
C₁= [symbol] ; S₁= [symbol]
C₂= [symbol] ; S₂= [symbol] _{°}

7. The method as recited in claim 2 wherein said length of the new perfect orthogonal complementary code pairs mate can be doubled in the following steps:
The parity bits of the code C₁ composed of [symbol] and [symbol] ; respectively, the parity bits of the code S₁ composed of [symbol] and [symbol] respectively, the parity bits of the code C₂ composed of [symbol] and [symbol] respectively, and the parity bits of the code S₂ composed of [symbol] and [symbol] respectively.

8. The method as recited in claim 4 wherein said required length N of the new perfect orthogonal complementary code pairs mate can be obtained by continuous use of above said steps.

9. The method as recited in claim 1 wherein selecting said basic time, space, frequency coding expansion matrix further comprising:
a) Determining the number of columns L of the expansion matrix by the relation Δ≧NL−1, where N denotes the length of the basic perfect orthogonal complementary dual code, L represents the number of columns of the expansion matrix, the unit of Δ is calculated by the number of chips in accordance with the size of the required zero relevant window Δ,
b) Selecting the number of the basic weak-related random variables (code elements) according to engineering requirements for said available time, frequency, size of the space and system complexity,
c) Deciding the number M of each group address code, where M represents rows of the expansion matrix, according to the complexity of the system and the requirements to improve the efficiency of spectrum, and
d) Constructing the basic coding expansion matrix according to the number of the weak-related random variables for available time, frequency and space, as well as the required rows M and columns L of the expansion matrix.

10. The method as recited in claim 9 wherein said basic coding expansion matrix can be constructed with the following basic requirements:
a) Each row vectors being arranged as many as possible of the weak correlated random elements, or only constant elements;
b) The expand matrix being a row full-rank matrix, each row vector being linear independent;
c) The vice peak of the cycle and the acylic autocorrelation function of each row vectors being as small as possible, and
d) The vice peak of the cycle and the acylic autocorrelation function of each column vectors being as small as possible;

11. The method as recited in claim 9 wherein said basic coding expansion matrix can be a random matrix, a constant matrix, or even a constant.

12. The method as recited in claim 9 wherein said number of weak-correlated random elements in row vectors is equal to the hidden diversity multiplicity of the wireless communications system.

13. The method as recited in claim 9 wherein said autocorrelation function within the window of the group code is whether good or not is determined by said autocorrelation function of each row vector.

14. The method as recited in claim 9 wherein said cross correlation function within the window of the group code is whether good or not is determined by said cross correlation function of each row vector.

15. The method as recited in claim 1 wherein said basic perfect orthogonal complementary code pairs mate groups are generated by said basic perfect orthogonal complementary code pairs mate and said basic time, space, frequency coding expansion matrix.

16. The method as recited in claim 1 wherein said each expanded address code group possess the corresponding category and number of hidden diversity multiplicity with the random variables, at the same time, there is a zero correlation window in the vicinity of the origin among cross correlation functions of different address codes in different code groups with the width of the window determined by said basic length of the perfect orthogonal complementary code pairs mate group.

17. The method as recited in claim 1 wherein expansion of said basic perfect orthogonal complementary code pairs mate group is carried out in accordance with the relation of the spanning tree, where the nature of address codes in each code group expanded by the spanning tree is totally determined by said basic perfect complementary code group in the initial roots of the spanning tree.

18. The method as recited in claim 1 wherein transforming said spanning tree can be referred to the exchange between S code and C code of the spanning tree.

19. The method as recited in claim 1 wherein said transforming spanning tree can be formed by negating one of said S code and C code of the spanning tree, or both taking the reverse form.

20. The method as recited in claim 1 wherein said transformed spanning tree can be generated by the use of inverted sequences, which take the inverse order of the S code and C code at the same time.

21. The method as recited in claim 1 wherein said transformed spanning tree can be formed by interlacing the polarity of the code bits.

22. The method as recited in claim 1 wherein said transformed spanning tree can be formed by uniform rotation transformation of the code bits in the complex plane.

23. The method as recited in claim 1 wherein said transformed spanning tree can be formed by re-arranging the column synchronization of the code C and code S in the spanning tree, where the unit of the column is based on the code of said basic perfect orthogonal complementary code pairs mate group.

24. The method as recited in claim 1 wherein said unit of said address code is the group, and there are a fixed number of codes in each group where the cross-correlation function of said address codes in each code group possesses the zero correlation window.

25. The method as recited in claim 1 wherein said hidden diversity multiplicity of said address code is very high, whose effective diversity multiplicity is equal to the product of the number of weak-correlated time, space, frequency random variables in the coding elements and the time diffusing amount of the chip-based channel in the window.

26. The method as recited in claim 1 wherein said unit of said address code is a group with each group including a certain number of codes and said cross-correlation function of the codes among different groups possesses the zero-correlated-window feature.

27. The method as recited in claim 1 wherein said autocorrelation function of codes among different address code groups and said cross-correlation function of the inter-symbol does not require to be ideal, and the zero correlation window do not necessarily require to exist.

28. The method as recited in claim 1 wherein said size of said zero correlation windows can be adjusted among said address code groups.

29. The method as recited in claim 28 wherein said adjustment method can be described as the adjustment of the length of the basic orthogonal complementary dual code.

30. The method as recited in claim 28 wherein said adjustment method can be described as the adjustment of the number of columns of said basic time, space, frequency expansion matrix.

31. The method as recited in claim 28 wherein said adjustment method can be described as the adjustment of the number of zero element of said coding expansion matrix in said spanning tree.

32. The method as recited in claim 1 wherein said number of codes within various address code groups can be adjusted through adjusting the number of rows of the basic time, space, frequency coding expansion matrix.

33. The method as recited in claim 1 wherein said autocorrelation function of codes within various address code groups is mainly determined by said cross correlation feature of each row of said selected basic time, space, frequency coding expansion matrix, and said cross correlation function of each code within a group mainly determined by said cross correlation feature of said corresponding rows of said selected time, space, frequency coding expansion matrix within said zero correlation window.

34. The method as recited in claim 1 wherein said autocorrelation and said cross correlation feature of each address code including the address code within a group determined by said basic orthogonal complementary code pairs mate and the structure of said corresponding spanning tree outside said zero correlation window.

35. The method as recited in claim 1 wherein said time, space, frequency coding expansion matrix can be arbitrary matrix.

36. The method as recited in claim 35 wherein said time, space, frequency coding expansion matrix can be the time-space matrix, time-frequency matrix, time-space-frequency matrix, and even can be a constant matrix or constant.
